(19) United States
(12) Patent Application Publication
(10) Pub. No.: US 2026/0189581 A1
(43) Pub. Date: Jul. 2, 2026

(54) DECISION GATE CONTROL FOR REPUTATION DETERMINATION

(71) Applicant: UAB 360 IT, Vilnius (LT)

(72) Inventor: Mantas Briliauskas, Vilnius (LT)

(21) Appl. No.: 19/004,556

(22) Filed: Dec. 30, 2024

(51) Int. Cl. H04L 9/40

(52) U.S. Cl. CPC H04L 63/1425; H04L 63/1441

(57) ABSTRACT

One or more computing devices, systems, and/or methods are provided. In an example, a decision gate control configuration including an arrangement of decision gates may be generated based upon decision gate profiles associated with the decision gates. A decision gate profile of the decision gate profiles may be indicative of a speed indicator associated with a decision gate, a value indicator associated with the decision gate, a cost indicator associated with the decision gate, and/or an output type associated with the decision gate. A first reputation decision associated with a content item may be determined using the decision gate control configuration. The first reputation decision associated with the content item may be applied.

### BACKGROUND

Malicious items, such as compromised web pages, infected files, etc., may exploit vulnerabilities in computer systems, which may lead to data breaches, financial losses, and privacy violations. Proactive protection may be used to prevent harm associated with such threats.

### SUMMARY

In accordance with the present disclosure, one or more computing devices and/or methods are provided. In an example, a first reputation decision stage may be performed. The first reputation decision stage may comprise executing one or more first decision gates of a decision gate control configuration to determine a first reputation decision (e.g., likely malicious, truly malicious, likely clean, truly clean, etc.) associated with a content item (e.g., a uniform resource locator (URL), a file, an email, etc.). The first reputation decision may be applied during a first time period. A second reputation decision stage may be performed. The second reputation decision stage may comprise executing one or more second decision gates of the decision gate control configuration to determine a second reputation decision associated with the content item. The second reputation decision may be applied during a second time period after the first time period.

In an example, a decision gate control configuration comprising an arrangement of decision gates may be generated based upon decision gate profiles associated with the decision gates. A decision gate profile of the decision gate profiles may be indicative of a speed indicator associated with a decision gate, a value indicator associated with the decision gate, a cost indicator associated with the decision gate, and/or an output type associated with the decision gate. A first reputation decision (e.g., likely malicious, truly malicious, likely clean, truly clean, etc.) associated with a content item (e.g., a URL, a file, an email, etc.) may be determined using the decision gate control configuration. The first reputation decision associated with the content item may be applied.

In an example, decision gates may be grouped into a plurality of groups based upon speed indicators and/or output types associated with the decision gates. The plurality of groups may comprise (i) a first group of decision gates associated with at a first set of output types and/or a first speed indicator range and/or (ii) a second group of decision gates associated with a second set of output types and/or a second speed indicator range. A decision gate control configuration may be generated based upon the plurality of groups. The decision gate control configuration may be used to perform a reputation decision process associated with a content item (e.g., a URL, a file, an email, etc.) to determine a first reputation decision (e.g., likely malicious, truly malicious, likely clean, truly clean, etc.) associated with the content item.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating an example system for determining reputation decisions associated with content items, where a decision gate control configuration is generated based upon decision gate profiles associated with decision gates, according to some embodiments.

FIG. 1B is a diagram illustrating an example system for determining reputation decisions associated with content items, where a decision gates are grouped into a plurality of groups, according to some embodiments.

FIG. 1C is a diagram illustrating an example system for determining reputation decisions associated with content items, where a decision gate control configuration is used to determine a reputation decision associated with a content item and/or the reputation decision is applied using a reputation decision application module, according to some embodiments.

FIG. 1D is a diagram illustrating an example arrangement of a group of decision gates in a graph, according to some embodiments.

FIG. 1E is a diagram illustrating an example system for determining reputation decisions associated with content items, where a decision gates of a group are used to determine a group reputation decision, according to some embodiments.

FIG. 1F is a diagram illustrating an example system for determining reputation decisions associated with content items, where a threat alert page is displayed on a client device, according to some embodiments.

FIG. 1G is a diagram illustrating an example system for determining reputation decisions associated with content items, where a self-learning module is used to generate an updated decision gate control configuration, according to some embodiments.

FIG. 2A is a diagram illustrating an example system for determining reputation decisions associated with content items, where a stage selection process is performed to select decision gates and/or groups of decision gates for execution in stages associated with a multi-stage decision gate control configuration, according to some embodiments.

FIG. 2B is a diagram illustrating an example system for determining reputation decisions associated with content items, where a multi-stage decision gate control configuration is used to determine a real-time reputation decision associated with a content item and/or the real-time reputation decision is applied using a reputation decision application module, according to some embodiments.

FIG. 2C is a diagram illustrating an example system for determining reputation decisions associated with content items, where a multi-stage decision gate control configuration is used to determine a deeper evaluation reputation decision associated with a content item and/or the deeper evaluation reputation decision is applied using a reputation decision application module, according to some embodiments.

FIG. 3 is a flow chart illustrating an example method for determining reputation decisions associated with content items, according to some embodiments.

FIG. 4 is a flow chart illustrating an example method for determining reputation decisions associated with content items, according to some embodiments.

FIG. 5 is a flow chart illustrating an example method for determining reputation decisions associated with content items, according to some embodiments.

FIG. 6 is an illustration of a scenario involving various examples of networks that may connect servers and clients, according to some embodiments.

FIG. 7 is an illustration of a scenario involving an example configuration of a server that may utilize and/or implement at least a portion of the techniques presented herein, according to some embodiments.

FIG. 8 is an illustration of a scenario involving an example configuration of a client that may utilize and/or implement at least a portion of the techniques presented herein, according to some embodiments.

FIG. 9 is an illustration of a scenario featuring an example non-transitory machine readable medium, according to some embodiments.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

Accurately determining a reputation associated with a content item (e.g., a uniform resource locator (URL), a file, an email, etc.) may be critical for a threat protection system to protect systems from malicious activities. Some reputation services rely on databases of known malicious content items, heuristic analysis, and third-party reputation scores to classify content items as clean, malicious, or suspicious. However, such reputation services may be unreliable due to relying heavily on external sources and/or information (e.g., third-party sourced traffic) that isn't reviewed. Such reputation services may also be complex and/or difficult to modify and/or update. Further, a speed versus accuracy tradeoff may be difficult (and/or impossible) to control using such reputation services.

In some examples, a decision gate control system is provided which uses decision gate profiles to generate and/or update a decision gate control configuration. For example, the decision gate control system may group decision gates into groups (e.g., decision gate groups (DGGs)) of decision gates based upon speed, output type, and/or other information indicated by the decision gate profiles. The decision gate control configuration may comprise a graph (e.g., a directed acyclic graph (DAG)) comprising an arrangement of decision gates and/or the groups, which may be optimized using a fitness function with dynamic and/or adjustable weights. The decision gate control configuration may be used to determine a reputation decision associated with a content item. In an example, the content item may comprise a URL and/or the reputation decision (e.g., URL reputation) may be provided as part of a URL curation service. Other types of content items are within the scope of the present disclosure.

The decision gate control system may comprise a self-learning module for automatically updating the decision gate control configuration (using logged usage information, for example) to improve the decision gate control configuration over time, thereby providing for improved adaptability of the decision gate control system where the decision gate control system can adjust to new threats over time. The decision gate control configuration may provide for improved control for mitigating (and/or balancing) false positives and false negatives. In some examples, a modular design of the decision gate control system may simplify adding new functionalities to the decision gate control system.

In some examples, the decision gate control configuration may comprise a multi-stage decision gate control configuration. One or more first stages of the multi-stage decision gate control configuration may be performed to provide a real-time (e.g., split-second) reputation decision. One or more second stages of the multi-stage decision gate control configuration may be performed to provide a deeper evaluation (e.g., offline) reputation decision. In some examples, the multi-stage decision gate control configuration may be configured such that stages may be performed concurrently and/or separately, and/or an outcome of a first stage (e.g., a stage with relatively low cost and/or high speed decision gates) may determine whether to trigger a second stage (e.g., a stage with relatively high cost and/or low speed decision gates).

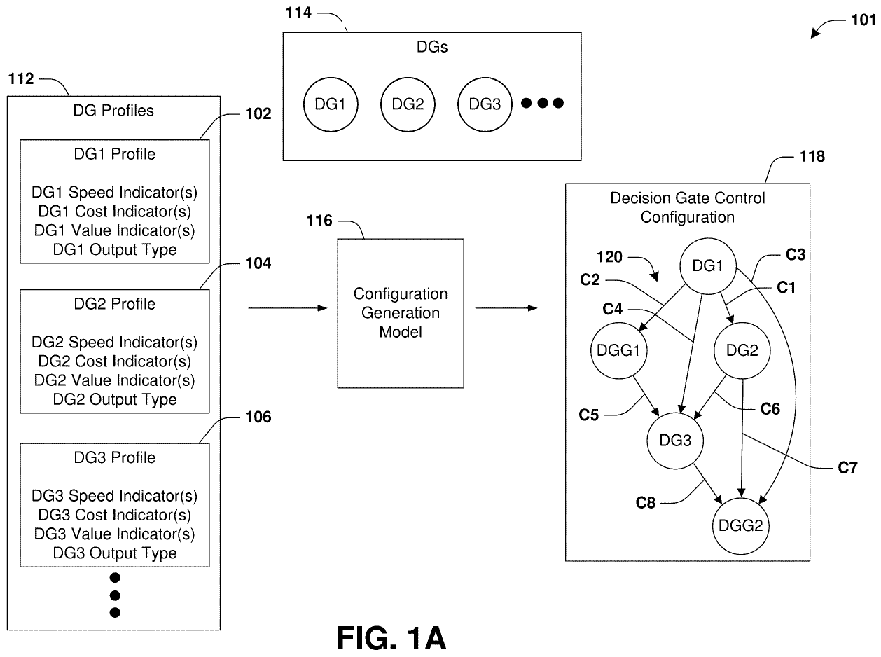

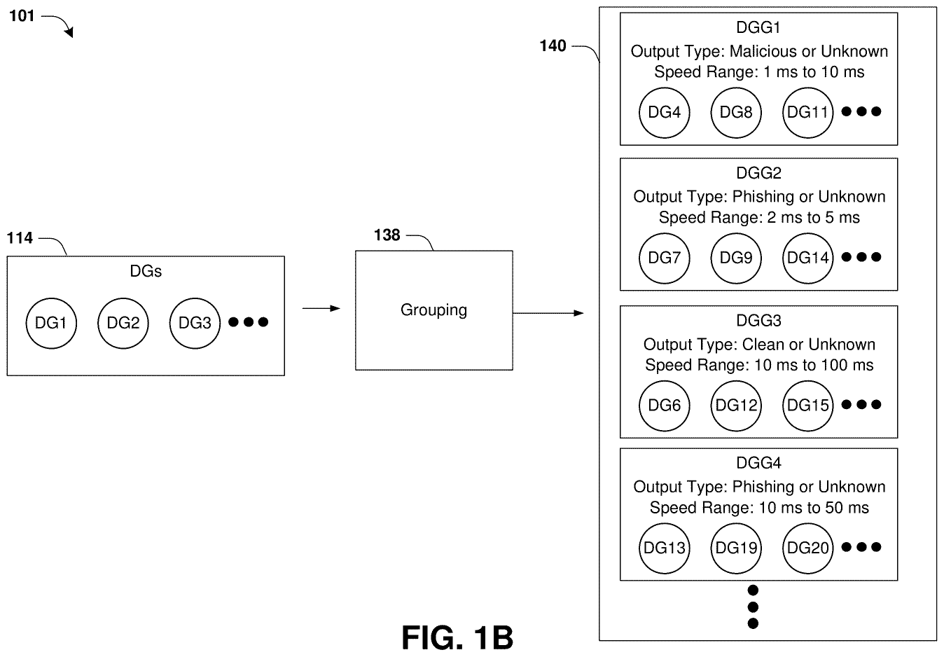

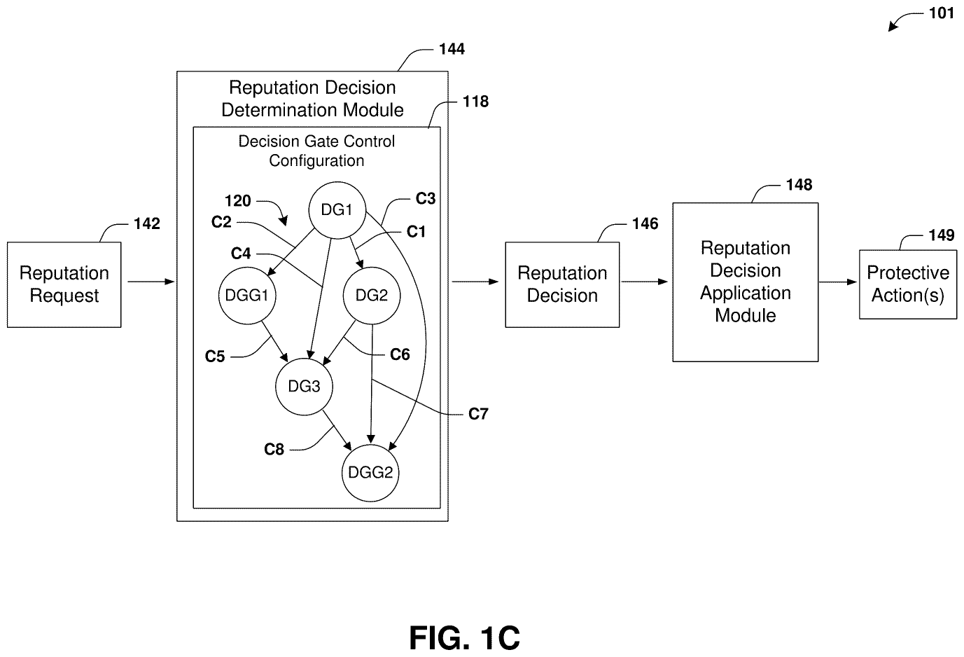

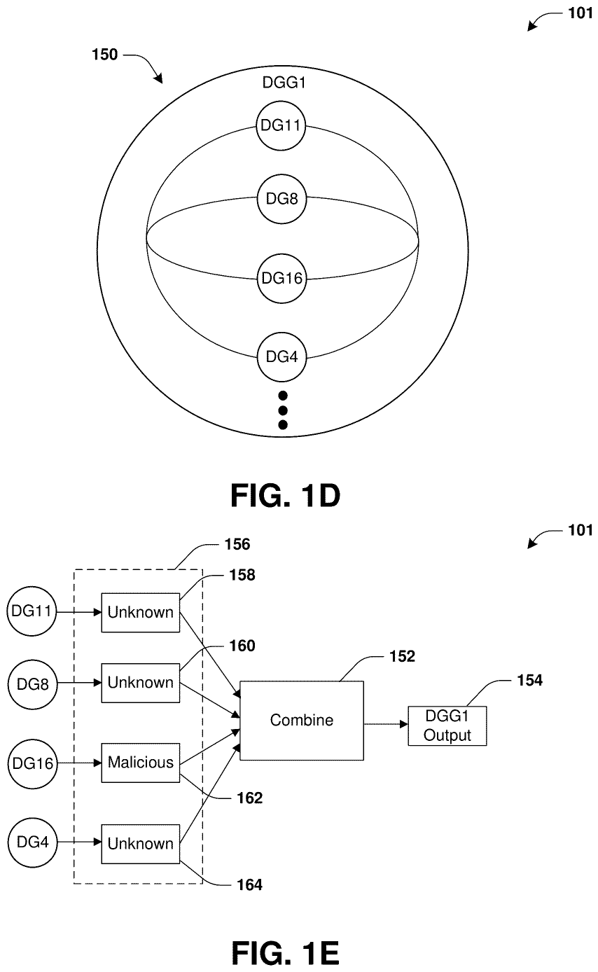

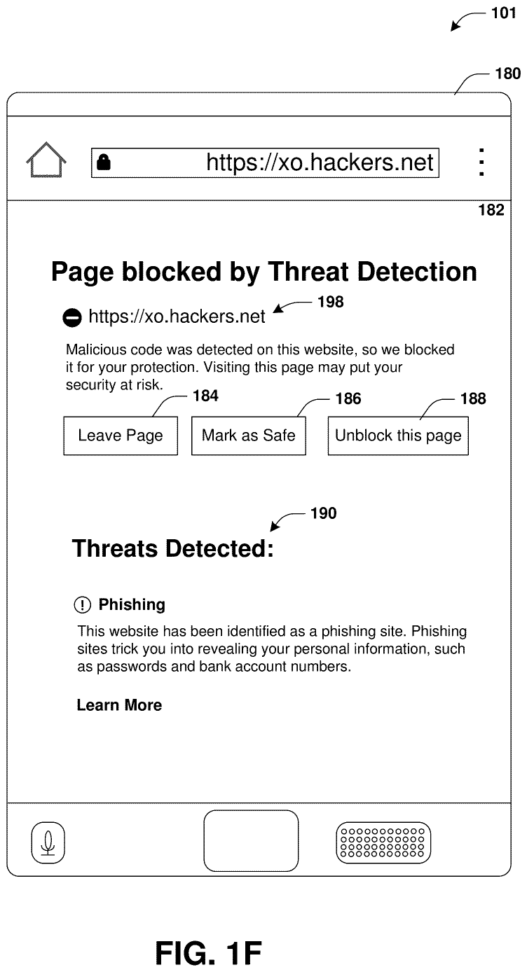

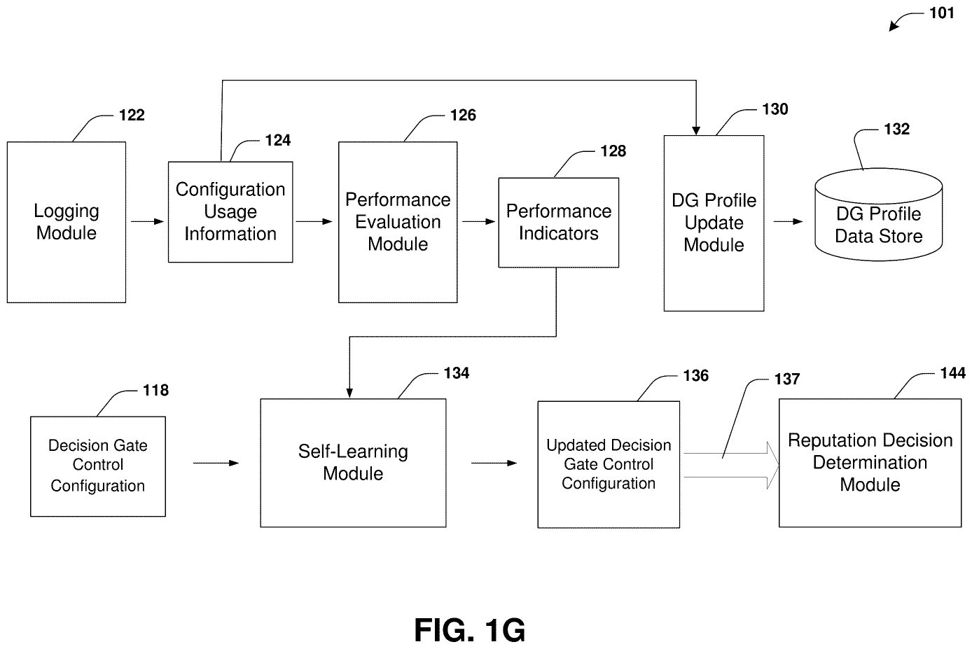

FIGS. 1A-1G illustrate examples of a system 101 (e.g., a decision gate control system) for determining reputation decisions associated with content items. FIG. 1A illustrates a configuration generation model 116 being used to generate a decision gate control configuration 118, in accordance with some embodiments. In some examples, the configuration generation model 116 may be provided with a first plurality of decision gate profiles 112 associated with a first plurality of decision gates 114. In some examples, the configuration generation model 116 may retrieve the first plurality of decision gate profiles 112 from a decision gate profile data store 132 (shown in FIG. 1G) configured to store and/or maintain decision gate profiles comprising the first plurality of decision gate profiles 112. The configuration generation model 116 may order and/or arrange decision gates of the first plurality of decision gates 114 based upon the first plurality of decision gate profiles 112 to generate the decision gate control configuration 118. In some examples, the configuration generation model 116 may use a first machine learning model to generate the decision gate control configuration 118. For example, the first machine learning model may be trained to (i) group decision gates into groups and/or (ii) order and/or arrange decision gates and/or groups of decision gates.

The first plurality of decision gate profiles 112 may comprise (i) a first decision gate profile 102 associated with a first decision gate DG1 of the first plurality of decision gates 114, (ii) a second decision gate profile 104 associated with a second decision gate DG2 of the first plurality of decision gates 114, (iii) a third decision gate profile 106 associated with a third decision gate DG3 of the first plurality of decision gates 114, and/or (iv) one or more other decision gate profiles associated with one or more other decision gates of the first plurality of decision gates 114.

In some examples, a decision gate (e.g., at least one of the first decision gate DG1, the second decision gate DG2, the third decision gate DG3, etc.) of the first plurality of decision gates 114 may be associated with a gate reputation decision process. For example, the first decision gate DG1 may comprise (and/or may comprise a link to) a first logical unit configured to perform a first gate reputation decision process, the second decision gate DG2 may comprise (and/or may comprise a link to) a second logical unit configured to perform a second gate reputation decision process, and/or the third second decision gate DG3 may comprise (and/or may comprise a link to) a third logical unit configured to perform a third gate reputation decision process.

In some examples, a decision gate profile (e.g., at least one of the first decision gate profile 102, the second decision gate profile 104, the third decision gate profile 106, etc.) of the first plurality of decision gate profiles 112 may be indicative of (i) one or more speed indicators associated with a decision gate, (ii) one or more cost indicators associated with the decision gate, (iii) one or more value indicators associated with the decision gate, (iv) an output type associated with the decision gate, and/or (iv) other information associated with the decision gate.

A speed indicator may comprise (and/or may be based upon) a speed with which a process of a decision gate is performed and/or a duration of time it takes for the process to be performed. For example, the first decision gate profile 102 associated with the first decision gate DG1 may be indicative of a first speed indicator comprising (and/or based upon) a speed with which the first gate reputation decision process associated with the first decision gate DG1 is performed and/or a duration of time it takes for the reputation decision process to be performed. In some examples, the first speed indicator may be determined based upon historical information associated with the first decision gate DG1. In some examples, the historical information may be indicative of runtimes (and/or other information) associated with instances of the first gate reputation decision process being executed. The historical information may be logged by a logger (in response to the logger detecting the first decision gate DG1 being executed to perform the first gate reputation decision process, for example).

A cost indicator may be indicative of a cost associated with a process of a decision gate. For example, the first decision gate profile 102 associated with the first decision gate DG1 may be indicative of a first cost indicator indicative of a cost (e.g., at least one of memory cost, processing cost, energy cost, monetary cost, etc.) of performing the first gate reputation decision process. The first cost indicator may be determined based upon cost information comprising (i) a measure of processing power used by one or more processors to perform the first gate reputation decision process, (ii) a measure of memory usage used by one or more memory units to perform the first gate reputation decision process, (iii) a measure of instructions executed to perform the first gate reputation decision process, (iv) a measure of input/output (I/O) operations executed to perform the first gate reputation decision process, (v) a measure of memory bandwidth associated with performing the first gate reputation decision process, (vi) a measure of network usage (e.g., Internet usage) associated with performing the first gate reputation decision process, (vii) a measure of energy usage associated with performing the first gate reputation decision process (e.g., the measure of energy usage may be in units of at least one of watts, watt-hours, joules, etc.), (viii) a monetary cost associated with performing the first gate reputation decision process (e.g., the monetary cost may be indicative of an amount of compensation to be provided to one or more entities for performing the first gate reputation decision process), and/or (ix) other information associated with a cost of performing the first gate reputation decision process. In some examples, the cost information (and/or the first cost indicator) may be determined based upon the historical information associated with the first decision gate DG1.

A value indicator may be indicative of a value associated with a process of a decision gate. For example, the first decision gate profile 102 associated with the first decision gate DG1 may be indicative of a first value indicator indicative of a value associated with performing the first gate reputation decision process. The first value indicator may be determined based upon value information comprising (i) an accuracy associated with outputs of the first gate reputation decision process, (ii) a precision associated with outputs of the first gate reputation decision process, (iii) a usefulness associated with outputs of the first gate reputation decision process, and/or (iv) other information associated with a value of performing the first gate reputation decision process. In some examples, the value information (and/or the first value indicator) may be determined based upon the historical information associated with the first decision gate DG1.

In some examples, the decision gate control configuration 118 may comprise a graph 120. The graph 120 may be a directed acyclic graph (DAG). Other graph types of the graph 120 are within the scope of the present disclosure. The configuration generation model 116 may generate the graph 120 to have nodes corresponding to decision gates of the first plurality of decision gates 114. In some examples, the configuration generation model 116 may arrange the nodes in the graph 120 based upon decision gate profiles associated with the decision gates corresponding to the nodes. In some examples, the configuration generation model 116 may generate connection lines (e.g., edges) between nodes of the graph 120. The connection lines may comprise at least one of a connection line C1, a connection line C2, a connection line C3, a connection line C4, a connection line C5, a connection line C6, a connection line C7, a connection line C8, etc. A connection line of the graph 120 may be indicative of a flow direction. In some examples, the arrangement of decision gates and/or the connection lines in the graph 120 determines a flow with which decision gates are executed in a reputation decision process performed using the decision gate control configuration 118.

In some examples, the configuration generation model 116 may group decision gates of the first plurality of decision gates 114 into a plurality of groups 140. FIG. 1B illustrates determination of the plurality of groups 140 by using the configuration generation model 116 to perform a grouping process 138. The grouping process 138 may be performed based upon the first plurality of decision gate profiles 112. In an example, the plurality of groups 140 may comprise a first group of decision gates DGG1, a second group of decision gates DGG2, a third group of decision gates DGG3, a fourth group of decision gates DGG4, and/or one or more other groups of decision gates.

In some examples, the configuration generation model 116 may group decision gates into the plurality of groups 140 based upon output types and/or speed indicators (and/or other information, such as cost indicators and/or value indicators) associated with the decision gates (e.g., the output types and/or the speed indicators associated with the decision gates may be retrieved from decision gate profiles associated with the decision gates). For example, the configuration generation model 116 may group decision gates together in a group based upon shared characteristics between the decision gates, such as the same (and/or similar) output types, the same (and/or similar) speeds, the same (and/or similar) costs, and/or the same (and/or similar) values. The first group DGG1 may be associated with a first set of output types (e.g., a set of one or more output types) and/or a first speed indicator range. The second group DGG2 may be associated with a second set of output types (e.g., a set of one or more output types) and/or a second speed indicator range. The third group DGG3 may be associated with a third set of output types (e.g., a set of one or more output types) and/or a third speed indicator range. The fourth group of decision gates DGG4 may be associated with a fourth set of output types (e.g., a set of one or more output types) and/or a fourth speed indicator range. In some examples, each group of the plurality of groups 140 is associated with merely a single output type (e.g., all decision gates of the group have the same output type). Embodiments are contemplated in which one or more groups of the plurality of groups 140 are associated with multiple output types, such as where decision gates in a group of the plurality of groups 140 have different output types.

The first set of output types associated with the first group DGG1 may comprise a first output type. For example, one, some or all decision gates of the first group DGG1 are configured to produce gate reputation decisions having the first output type. The first output type may be at least one of a “Malicious or Unknown” output type, a “Phishing or Unknown” output type, a “Malware or Unknown” output type, a “Clean or Unknown” output type, etc. In a scenario shown in FIG. 1B, for example, in which the first output type is the “Malicious or Unknown” output type, a decision gate of the first group DGG1 may be configured to produce a reputation decision indicative of either (i) a malicious finding indicating that a content item is determined to be potentially malicious or (ii) an inconclusive finding indicating that whether or not the content item is malicious is inconclusive. The first speed indicator range may correspond to a range of speeds with which processes of decision gates in the first group DGG1 are performed and/or a range of durations of time it takes for the process to be performed. In a scenario shown in FIG. 1B, for example, in which the first speed indicator range ranges from 1 millisecond to 10 milliseconds, decision gates (e.g., DG4, DG8, DG11, etc.) that are included in the first group DGG1 may be associated with speed indicators that are between about 1 millisecond to about 10 milliseconds (e.g., each of the decision gates of the first group DGG1 may be associated with a process that takes a duration of between about 1 millisecond to about 10 milliseconds to be executed).

The second set of output types associated with the second group DGG2 may comprise a second output type. For example, one, some or all decision gates of the second group DGG2 are configured to produce gate reputation decisions having the second output type. The second output type may be at least one of a “Malicious or Unknown” output type, a “Phishing or Unknown” output type, a “Malware or Unknown” output type, a “Clean or Unknown” output type, etc. In a scenario shown in FIG. 1B, for example, in which the second output type is the “Phishing or Unknown” output type, a decision gate of the second group DGG2 may be configured to produce a reputation decision indicative of either (i) a phishing finding indicating that a content item is determined to be potentially associated with phishing activity or (ii) an inconclusive finding indicating that whether or not the content item is associated with phishing activity is inconclusive. The second speed indicator range may correspond to a range of speeds with which processes of decision gates in the second group DGG2 are performed and/or a range of durations of time it takes for the process to be performed. In a scenario shown in FIG. 1B, for example, in which the second speed indicator range ranges from 2 milliseconds to 5 milliseconds, decision gates (e.g., DG7, DG9, DG14, etc.) that are included in the second group DGG2 may be associated with speed indicators that are between about 2 milliseconds to about 5 milliseconds (e.g., each of the decision gates of the second group DGG2 may be associated with a process that takes a duration of between about 2 milliseconds to about 5 milliseconds to be executed).

The third set of output types associated with the third group DGG3 may comprise a third output type. For example, one, some or all decision gates of the third group DGG3 are configured to produce gate reputation decisions having the third output type. The third output type may be at least one of a “Malicious or Unknown” output type, a “Phishing or Unknown” output type, a “Malware or Unknown” output type, a “Clean or Unknown” output type, etc. In a scenario shown in FIG. 1B, for example, in which the third output type is the “Clean or Unknown” output type, a decision gate of the third group DGG3 may be configured to produce a reputation decision indicative of either (i) a clean finding indicating that a content item is determined to be potentially clean and/or not malicious or (ii) an inconclusive finding indicating that whether or not the content item is clean is inconclusive. The third speed indicator range may correspond to a range of speeds with which processes of decision gates in the third group DGG3 are performed and/or a range of durations of time it takes for the process to be performed. In a scenario shown in FIG. 1B, for example, in which the third speed indicator range ranges from 10 millisecond to 100 milliseconds, decision gates (e.g., DG7, DG9, DG14, etc.) that are included in the third group DGG3 may be associated with speed indicators that are between about 10 milliseconds to about 100 milliseconds (e.g., each of the decision gates of the third group DGG3 may be associated with a process that takes a duration of between about 10 milliseconds to about 100 milliseconds to be executed).

The fourth set of output types associated with the fourth group DGG4 may comprise a fourth output type. For example, one, some or all decision gates of the fourth group DGG4 are configured to produce gate reputation decisions having the fourth output type. The fourth output type may be at least one of a “Malicious or Unknown” output type, a “Phishing or Unknown” output type, a “Malware or Unknown” output type, a “Clean or Unknown” output type, etc. In a scenario shown in FIG. 1B, for example, in which the fourth output type is the “Phishing or Unknown” output type, a decision gate of the fourth group DGG4 may be configured to produce a reputation decision indicative of either (i) a phishing finding indicating that a content item is determined to be potentially associated with phishing activity or (ii) an inconclusive finding indicating that whether or not the content item is associated with phishing activity is inconclusive. The fourth speed indicator range may correspond to a range of speeds with which processes of decision gates in the fourth group DGG4 are performed and/or a range of durations of time it takes for the process to be performed. In a scenario shown in FIG. 1B, for example, in which the fourth speed indicator range ranges from 10 millisecond to 50 milliseconds, decision gates (e.g., DG7, DG9, DG14, etc.) that are included in the fourth group DGG4 may be associated with speed indicators that are between about 10 milliseconds to about 50 milliseconds (e.g., each of the decision gates of the fourth group DGG4 may be associated with a process that takes a duration of between about 10 milliseconds to about 50 milliseconds to be executed).

In some examples, the decision gate control configuration 118 may be used to perform reputation decision processes to determine reputation decisions associated with content items. In an example scenario shown in FIG. 1C, a first reputation decision process for determining a first reputation decision 146 associated with a first content item may be triggered in response to receiving a request 142 associated with the first content item. Alternatively and/or additionally, the first reputation decision process may be triggered automatically in response to determining that one or more conditions associated with the first content item are met. Alternatively and/or additionally, the first reputation decision process may be performed as part of a reputation monitoring service that executes reputation decision processes for the first content item in a periodic and/or aperiodic manner.

In some examples, the first content item may comprise at least one of a uniform resource locator (URL), a file, an email, a video, or other type of content. In some examples, the first reputation decision process may be performed using a reputation decision determination module 144. For example, the reputation decision determination module 144 may execute decision gates of the decision gate control configuration 118 in accordance with an arrangement and/or flow configured by the decision gate control configuration 118.

During the first reputation decision process, the reputation decision determination module 144 may execute the first decision gate DG1 to determine a first gate reputation decision associated with the first content item. For example, to execute the first decision gate DG1, the reputation decision determination module 144 may trigger the first logical unit associated with the first decision gate DG1 to perform the first gate reputation decision process to determine the first gate reputation decision. In some examples, in response to executing the first decision gate DG1 to determine the first gate reputation decision, the reputation decision determination module 144 may determine one or more subsequent decision gates to execute based upon one or more connection lines of the graph 120.

In some examples, a connection line of the graph 120 of the decision gate control configuration 118 is indicative of a direction of flow between decision gates and/or groups of decision gates. For example, connection lines (e.g., edges) connected to the first decision gate DG1 may comprise (i) the connection line C1 indicative of a direction of flow from the first decision gate DG1 to the second decision gate DG2, (ii) the connection line C2 indicative of a direction of flow from the first decision gate DG1 to the first group DGG1, (iii) the connection line C3 indicative of a direction of flow from the first decision gate DG1 to the second group DGG2, and/or (iv) the connection line C4 indicative of a direction of flow from the first decision gate DG1 to the third decision gate DG3. In an example, in response to executing the first decision gate DG1 to determine the first gate reputation decision, the reputation decision determination module 144 may (i) determine to execute the second decision gate DG2 based upon the connection line C1, (ii) determine to execute the first group DGG1 based upon the connection line C2, (iii) determine to execute the second group DGG2 based upon the connection line C3, and/or (iv) determine to execute the third decision gate DG3 based upon the connection line C4.

In some examples, a connection line of the graph 120 of the decision gate control configuration 118 is indicative of one or more dependencies between decision gates and/or groups of decision gates. The connection line C1 may be indicative of one or more first conditions associated with the first content item and/or the first gate reputation decision. In an example, the reputation decision determination module 144 may determine to execute the second decision gate DG2 after executing the first decision gate DG1 based upon a determination that the first content item and/or the first gate reputation decision (determined via execution of the first decision gate DG1) meet the one or more first conditions. The connection line C2 may be indicative of one or more second conditions associated with the first content item and/or the first gate reputation decision. In an example, the reputation decision determination module 144 may determine to execute the first group DGG1 after executing the first decision gate DG1 based upon a determination that the first content item and/or the first gate reputation decision (determined via execution of the first decision gate DG1) meet the one or more second conditions. The one or more first conditions may be the same as or different than the one or more second conditions. In an example, the one or more first conditions may comprise a condition that the first gate reputation decision (determined via execution of the first decision gate DG1) is indicative of a first value (e.g., malicious finding, phishing finding, malware finding, etc.) and the one or more second conditions may comprise a condition that the first gate reputation decision (determined via execution of the first decision gate DG1) is indicative of a second value (e.g., inconclusive finding). Thus, a flow with which decision gates are executed by the reputation decision determination module 144 may be impacted by outputs of the decision gates. In an example, the reputation decision determination module 144 may determine to execute the second decision gate DG2 following execution of the first decision gate DG1 based upon the first gate reputation decision (determined via execution of the first decision gate DG1) indicating the first value. Alternatively and/or additionally, the reputation decision determination module 144 may determine to execute the first group DGG1 following execution of the first decision gate DG1 based upon the first gate reputation decision (determined via execution of the first decision gate DG1) indicating the second value.

FIG. 1D illustrates an example representation 150 of an arrangement of decision gates of the first group DGG1 in the graph 120. In some examples, decision gates of the first group DGG1 are arranged in parallel in the graph 120. In some examples, the first group DGG1 may be executed to determine a first group reputation decision 154 (shown in FIG. 1E) associated with the first content item. In some examples, the execution of the first group DGG1 may comprise execution of one, some or all decision gates of the first group DGG1. In some examples, decision gates of the first group DGG1 may be executed asynchronously. In some examples, decision gates of the first group DGG1 may be executed concurrently. Alternatively and/or additionally, decision gates of the first group DGG1 may be executed separately and/or in different time periods.

FIG. 1E illustrates execution of the first group DGG1 to determine the first group reputation decision 154 associated with the first content item. In some examples, decision gates of the first group DGG1 are executed to determine a set of gate reputation decisions 156 (having the first output type, “Malicious or Unknown”, for example). For example, a logical unit associated with a decision gate DG11 of the first group DGG1 may be triggered to perform a gate reputation decision process to determine a gate reputation decision 158 (e.g., an inconclusive finding) associated with the first content item. Alternatively and/or additionally, a logical unit associated with a decision gate DG8 of the first group DGG1 may be triggered to perform a gate reputation decision process to determine a gate reputation decision 160 (e.g., an inconclusive finding) associated with the first content item. Alternatively and/or additionally, a logical unit associated with a decision gate DG16 of the first group DGG1 may be triggered to perform a gate reputation decision process to determine a gate reputation decision 162 (e.g., a malicious finding) associated with the first content item. Alternatively and/or additionally, a logical unit associated with a decision gate DG4 of the first group DGG1 may be triggered to perform a gate reputation decision process to determine a gate reputation decision 164 (e.g., an inconclusive finding) associated with the first content item.

In some examples, the first group reputation decision 154 may be determined based upon the set of gate reputation decisions 156. For example, the set of gate reputation decisions 156 may be combined using a combination module 152 to determine the first group reputation decision 154. In an example, the combination module 152 may perform an OR operation and/or one or more other operations on the set of gate reputation decisions 156 to determine the first group reputation decision 154. In an example, the first group reputation decision 154 may be set to be indicative of a malicious finding (indicating that the first content item is determined to be potentially malicious, for example) based upon the gate reputation decision 162 being indicative of a malicious finding associated with the first content item.

In some examples, during the first reputation decision process, the reputation decision determination module 144 may execute some and/or all decision gates and/or groups of decision gates of the decision gate control configuration 118 to determine a set of reputation decisions (comprising group reputation decisions and/or gate reputation decisions, for example). An order in which the reputation decision determination module 144 executes the decision gates and/or groups may be determined based upon the decision gate control configuration 118 (e.g., based upon connection lines connecting the decision gates and/or groups to each other). For example, during the first reputation decision process, the reputation decision determination module 144 may (i) execute the first decision gate DG1 to determine the first gate reputation decision associated with the first content item, (ii) execute the second decision gate DG2 to determine a second gate reputation decision associated with the first content item, (iii) execute the third decision gate DG3 to determine a third gate reputation decision associated with the first content item, (iv) execute the first group DGG1 to determine the first group reputation decision 154 (shown in FIG. 1E) associated with the first content item, and/or (v) execute the second group DGG2 to determine a second group reputation decision associated with the first content item.

In some examples, to execute the second decision gate DG2, the reputation decision determination module 144 may trigger the second logical unit associated with the second decision gate DG2 to perform the second gate reputation decision process to determine the second gate reputation decision associated with the first content item. In some examples, to execute the third decision gate DG3, the reputation decision determination module 144 may trigger the third logical unit associated with the third decision gate DG3 to perform the third gate reputation decision process to determine the third gate reputation decision associated with the first content item. In some examples, the reputation decision determination module 144 may execute one, some or all decision gates of the second group DGG2 to determine the second group reputation decision. In some examples, decision gates of the second group DGG2 are arranged in parallel in the graph 120. The reputation decision determination module 144 may execute the second group DGG2 to determine the second group reputation decision using one or more of the techniques provided herein with respect to executing the first group DGG1 to determine the first group reputation decision.

In some examples, the reputation decision determination module 144 may determine the first reputation decision 146 associated with the first content item based upon the set of reputation decisions, which may comprise (i) the first gate reputation decision determined using the first decision gate DG1, (ii) the second gate reputation decision determined using the second decision gate DG2, (iii) the third gate reputation decision determined using the third decision gate DG3, (iv) the first group reputation decision 154 determined using the first group DGG1, (v) the second group reputation decision determined using the second group DGG2, and/or (vi) one or more other reputation decisions determined using one or more decision gates and/or one or more groups of decision gates. In an example, one or more operations (e.g., mathematical operations) may be performed using the set of reputation decisions to determine the first reputation decision 146. Alternatively and/or additionally, the reputation decision determination module 144 may perform a decision aggregation process on the set of reputation decisions to determine the first reputation decision 146. The decision aggregation process may comprise at least one of a majority voting process, a weighted voting process, a stacking process, etc.

In some examples, an impact of a reputation decision of the set of reputation decisions on the first reputation decision 146 may be configured by a decision weight associated with the reputation decision. In some examples, the decision gate control configuration 118 may be indicative of (i) a first gate decision weight associated with the first decision gate DG1, (ii) a second gate decision weight associated with the second decision gate DG2, (iii) a third gate decision weight associated with the third decision gate DG3, (iv) a first group decision weight associated with the first group DGG1, and/or (v) a second group decision weight associated with the second group DGG2. In some examples, the reputation decision determination module 144 may (i) apply the first gate decision weight to the first gate reputation decision, (ii) apply the second gate decision weight to the second gate reputation decision, (iii) apply the third gate decision weight to the third gate reputation decision, (iv) apply the first group decision weight to the first group reputation decision 154, and/or (v) apply the second group decision weight to the second group reputation decision. In some examples, the first gate decision weight associated with the first decision gate DG1 may be determined based upon the first value indicator associated with the first decision gate DG1.

In some examples, the reputation decision determination module 144 may output a first confidence score associated with the first reputation decision 146. The first confidence score may be indicative of a likelihood that the first reputation decision 146 is correct. In some examples, the reputation decision determination module 144 may determine the first confidence score based upon a variance of reputation decisions in the set of reputation decisions associated with the first content item. In some examples, the reputation decision determination module 144 may decrease the first confidence score based upon identification of conflicting reputation decisions in the set of reputation decisions (e.g., one or more reputation decisions may indicate clean findings while one or more other reputation decisions may indicate phishing findings).

In some examples, decision gates of the decision gate control configuration 118 may be associated with different gate reputation decision processes. For example, the first gate reputation decision process (associated with the first decision gate DG1) performed to determine the first gate reputation decision may be different than (i) the second gate reputation decision process (associated with the second decision gate DG2) performed to determine the second gate reputation decision and/or (ii) the third gate reputation decision process (associated with the third decision gate DG3) performed to determine the third gate reputation decision.

In an example, a gate reputation decision process (e.g., at least one of the first gate reputation decision process, the second gate reputation decision process, the third gate reputation decision process, etc.) associated with a decision gate of the decision gate control configuration 118 may comprise a content item whitelist lookup process. The content item whitelist lookup process may comprise (i) accessing a whitelisted content item data structure to determine whether an indication of the first content item is included in the whitelisted content item data structure, and/or (ii) determining a gate reputation decision based upon the determination of whether an indication of the first content item was included in the whitelisted content item data structure. In an example, the gate reputation decision may be generated to indicate a clean finding (e.g., indicating that the first content item is determined to be potentially clean and/or not malicious) based upon an indication of the first content item being included in the whitelisted content item data structure. Alternatively and/or additionally, the gate reputation decision may be generated to indicate an inconclusive finding (e.g., indicating that whether the first content item is clean is inconclusive) based upon an indication of the first content item not being included in the whitelisted content item data structure.

In an example, a gate reputation decision process (e.g., at least one of the first gate reputation decision process, the second gate reputation decision process, the third gate reputation decision process, etc.) associated with a decision gate of the decision gate control configuration 118 may comprise a content item blacklist lookup process. The content item blacklist lookup process may comprise (i) accessing a blacklisted content item data structure to determine whether an indication of the first content item is included in the blacklisted content item data structure, and/or (ii) determining a gate reputation decision based upon the determination of whether an indication of the first content item was included in the blacklisted content item data structure. In an example, the gate reputation decision may be generated to indicate a malicious finding (e.g., indicating that the first content item is determined to be potentially malicious) based upon an indication of the first content item being included in the blacklisted content item data structure. Alternatively and/or additionally, the gate reputation decision may be generated to indicate an inconclusive finding (e.g., indicating that whether the first content item is malicious is inconclusive) based upon an indication of the first content item not being included in the blacklisted content item data structure.

In an example, a gate reputation decision process (e.g., at least one of the first gate reputation decision process, the second gate reputation decision process, the third gate reputation decision process, etc.) associated with a decision gate of the decision gate control configuration 118 may comprise a domain whitelist lookup process. The domain whitelist lookup process may comprise (i) determining a domain name associated with the first content item (e.g., in an example the first content item comprises a URL “www.shoes.shop/running”, the domain name may be determined to be “shoes.shop”), (ii) accessing a whitelisted domain name data structure to determine whether the domain name associated with the first content item is indicated by the whitelisted domain name data structure, and/or (iii) determining a gate reputation decision based upon the determination of whether the domain name associated with the first content item was indicated by the whitelisted domain name data structure. In an example, the gate reputation decision may be generated to indicate a clean finding (e.g., indicating that the first content item is determined to be potentially clean and/or not malicious) based upon the domain name being indicated by the whitelisted domain name data structure. Alternatively and/or additionally, the gate reputation decision may be generated to indicate an inconclusive finding (e.g., indicating that whether the first content item is clean is inconclusive) based upon the domain name not being indicated by the whitelisted domain name data structure.

In an example, a gate reputation decision process (e.g., at least one of the first gate reputation decision process, the second gate reputation decision process, the third gate reputation decision process, etc.) associated with a decision gate of the decision gate control configuration 118 may comprise a domain blacklist lookup process. The domain blacklist lookup process may comprise (i) determining the domain name associated with the first content item, (ii) accessing a blacklisted domain name data structure to determine whether the domain name associated with the first content item is indicated by the blacklisted domain name data structure, and/or (iii) determining a gate reputation decision based upon the determination of whether the domain name associated with the first content item was indicated by the blacklisted domain name data structure. In an example, the gate reputation decision may be generated to indicate a malicious finding (e.g., indicating that the first content item is determined to be potentially malicious) based upon the domain name being indicated by the blacklisted domain name data structure. Alternatively and/or additionally, the gate reputation decision may be generated to indicate an inconclusive finding (e.g., indicating that whether the first content item is malicious is inconclusive) based upon the domain name not being indicated by the blacklisted domain name data structure.

In an example, a gate reputation decision process (e.g., at least one of the first gate reputation decision process, the second gate reputation decision process, the third gate reputation decision process, etc.) associated with a decision gate of the decision gate control configuration 118 may comprise a URL whitelist lookup process. The URL whitelist lookup process may comprise (i) determining the URL (e.g., “www.shoes.shop/running”) associated with the first content item, (ii) accessing a whitelisted URL data structure to determine whether the URL associated with the first content item is indicated by the whitelisted URL data structure, and/or (iii) determining a gate reputation decision based upon the determination of whether the URL associated with the first content item was indicated by the whitelisted URL data structure. In an example, the gate reputation decision may be generated to indicate a clean finding (e.g., indicating that the first content item is determined to be potentially clean and/or not malicious) based upon the URL being indicated by the whitelisted URL data structure. Alternatively and/or additionally, the gate reputation decision may be generated to indicate an inconclusive finding (e.g., indicating that whether the first content item is clean is inconclusive) based upon the URL not being indicated by the whitelisted URL data structure.

In an example, a gate reputation decision process (e.g., at least one of the first gate reputation decision process, the second gate reputation decision process, the third gate reputation decision process, etc.) associated with a decision gate of the decision gate control configuration 118 may comprise a URL blacklist lookup process. The URL blacklist lookup process may comprise (i) determining the URL associated with the first content item, (ii) accessing a blacklisted URL data structure to determine whether the URL associated with the first content item is indicated by the blacklisted URL data structure, and/or (iii) determining a gate reputation decision based upon the determination of whether the URL associated with the first content item was indicated by the blacklisted URL data structure. In an example, the gate reputation decision may be generated to indicate a malicious finding (e.g., indicating that the first content item is determined to be potentially malicious) based upon the URL being indicated by the blacklisted URL data structure. Alternatively and/or additionally, the gate reputation decision may be generated to indicate an inconclusive finding (e.g., indicating that whether the first content item is malicious is inconclusive) based upon the URL not being indicated by the blacklisted URL data structure.

In an example, a gate reputation decision process (e.g., at least one of the first gate reputation decision process, the second gate reputation decision process, the third gate reputation decision process, etc.) associated with a decision gate of the decision gate control configuration 118 may comprise a strategic vendor process. The strategic vendor process may comprise (i) transmitting, to a service (e.g., a third party service), a request to determine a reputation decision associated with the first content item (e.g., the request may be indicative of the first content item), (ii) receiving, from the service, information responsive to the request (e.g., the information may be stored to a database), and/or (iii) determining a gate reputation decision based upon the information provided by the service. In an example, the gate reputation decision may be generated to indicate a malicious finding (e.g., indicating that the first content item is determined to be potentially malicious) based upon the information provided by the service indicating that the first content item is potentially malicious. Alternatively and/or additionally, the gate reputation decision may be generated to indicate a phishing finding (e.g., indicating that the first content item is associated with phishing activity) based upon the information provided by the service indicating that the first content item is potentially associated with phishing activity. Alternatively and/or additionally, the gate reputation decision may be generated to indicate a malware finding (e.g., indicating that the first content item is associated with malware) based upon the information provided by the service indicating that the first content item is potentially associated with malware. Alternatively and/or additionally, the gate reputation decision may be generated to indicate a clean finding (e.g., indicating that the first content item is determined to be potentially clean and/or not malicious) based upon the information provided by the service indicating that the first content item is potentially clean.

In an example, a gate reputation decision process (e.g., at least one of the first gate reputation decision process, the second gate reputation decision process, the third gate reputation decision process, etc.) associated with a decision gate of the decision gate control configuration 118 may comprise a deep analysis process. The deep analysis process may comprise evaluating, using a deep analysis module, information associated with the first content item to determine a gate reputation decision associated with the first content item. The information analyzed by the deep analysis module to determine the gate reputation decision may be indicative of internet activity associated with a web page (e.g., a web page associated with the first content item). In some examples, the deep analysis module may comprise a second machine learning model trained to determine the gate reputation decision based upon the information (e.g., based upon whether the information is indicative of anomalous and/or irregular internet activity). In an example, the gate reputation decision may be generated to indicate at least one of a malicious finding, a phishing finding, a malware finding, a clean finding, etc.

In an example, a gate reputation decision process (e.g., at least one of the first gate reputation decision process, the second gate reputation decision process, the third gate reputation decision process, etc.) associated with a decision gate of the decision gate control configuration 118 may comprise an expert analysis process in which an expert (e.g., an engineer) is tasked with manually analyzing information associated with the first content item to determine a reputation decision associated with the first content item. The strategic vendor process may comprise (i) transmitting, to a device associated with the expert, a request to determine a reputation decision associated with the first content item (e.g., the request may be indicative of the first content item), (ii) receiving, from the device associated with the expert, a reputation report, and/or (iii) determining a gate reputation decision based upon the reputation report provided by the expert. In an example, the gate reputation decision may be generated to indicate at least one of a malicious finding, a phishing finding, a malware finding, a clean finding, etc.

In some examples, the reputation decision determination module 144 may provide the first reputation decision 146 to a reputation decision application module 148 (shown in FIG. 1C) configured to apply the first reputation decision 146. For example, the reputation decision application module 148 may control access to the first content item and/or a first resource associated with the first content item based upon the first reputation decision 146. Alternatively and/or additionally, the reputation decision application module 148 may transmit an indication of the first reputation decision 146 to a threat protection device associated with a service to control access to the first content item and/or the first resource.

In some examples, one or more threat protection actions 149 associated with the first content item and/or the first resource may be performed (by the reputation decision application module 148 and/or the threat protection device) based upon the first reputation decision 146. In some examples, based upon the first reputation decision 146 indicating a potential threat (e.g., a malicious finding, a phishing finding and/or a malware finding and/or other finding associated with a potential threat), the one or more threat protection actions 149 may include restricting, blocking, limiting and/or obstructing access of one or more entities (e.g., users of a threat protection service) to the first content item and/or the first resource, which may (i) protect the one or more entities from potential threats such as phishing schemes, malware, a hacking attempt, etc., and/or (ii) reduce bandwidth used by the one or more entities as a result of restricting transmission of malicious content.

Alternatively and/or additionally, based upon the first reputation decision 146 indicating a potential threat, the one or more threat protection actions 149 may include (i) blocking the first content item and/or the first resource associated with the first content item from being stored and/or opened in a vulnerable environment, and/or (ii) storing and/or opening the first content item and/or the first resource in a secure environment, such as a sandbox and/or other type of environment (e.g., the secure environment may restrict a program of the first content item and/or the first resource from being executed automatically and/or may restrict the first content item and/or the first resource from negatively impacting the vulnerable environment), thereby protecting the vulnerable environment from potential threats such as malware, a hacking attempt, etc. Alternatively and/or additionally, based upon the first reputation decision 146 indicating a potential threat, the one or more threat protection actions 149 may include removing the first content item and/or the first resource from a content platform that hosts the first content item and/or the first resource.

In an example, the first resource may comprise a first web page. The first content item may comprise a URL to the first web page. Alternatively and/or additionally, the first content item may comprise a domain and/or other type of identifier associated with the first web page. In some examples, based upon the first reputation decision 146 indicating a malicious finding, a phishing finding and/or a malware finding (and/or other finding associated with a potential threat), the one or more threat protection actions 149 may include providing a threat detection alert to a client device attempting to access the first web page. For example, the reputation decision application module 148 and/or the threat protection device may provide a threat protection alert 182 (shown in FIG. 1F) to a client device 180 in response to determining that the client device 180 has attempted to access the first web page.

FIG. 1F illustrates display of the threat protection alert 182 on the client device 180. In some examples, the threat protection alert 182 may comprise a browser page displayed using a browser of the client device 180. The threat protection alert 182 comprise an indication 198 of the URL and/or an indication that the first web page associated with the URL is associated with a potential threat. The threat protection alert 182 may comprise a leave page selectable input 184 for navigating to a web page different than the first web page. The threat protection alert 182 may comprise a mark safe selectable input 186 for changing a setting associated with the threat protection service such that access to the first web page is no longer restricted by the threat protection service. The threat protection alert 182 may comprise an unblock selectable input 188 for navigating to the first web page. In some examples, the threat protection alert 182 may provide a list of threats 190. The list of threats 190 may be indicative of one or more threats indicated by the first reputation decision 146, such as at least one of phishing, malware, etc.

In some examples, based upon the first reputation decision 146 indicating a clean finding, the reputation decision application module 148 and/or the threat protection device may provide one or more users with access (e.g., unimpeded access) to the first content item and/or the first resource (without providing a threat protection alert, for example).

In some examples, the decision gate control configuration 118 may be dynamically updated via self-learning. FIG. 1G illustrates generation of an updated decision gate control configuration 136 based upon the decision gate control configuration 118 and/or a set of performance indicators 128. In some examples, a logging module 122 may be configured to log usage information 124 associated with use of the decision gate control configuration 118. The usage information 124 may be indicative of one or more historical events in which the decision gate control configuration 118 was used (by the reputation decision determination module 144) to determine a reputation decision associated with a content item. For example, the usage information 124 may comprise information associated with the first reputation decision process performed using the decision gate control configuration 118. For example, the usage information 124 may be indicative of (i) the first content item, (ii) the first reputation decision 146, (iii) a first processing time associated with performing the first reputation decision process, (iii) the first confidence score associated with the first reputation decision 146, and/or (iv) other information associated with the first reputation decision process. Alternatively and/or additionally, the usage information 124 may comprise information associated with other reputation decision processes performed using the decision gate control configuration 118.

In some examples, a performance evaluation module 126 may evaluate the usage information 124 to determine a set of performance indicators 128 (e.g., a set of one or more performance indicators) associated with the decision gate control configuration 118. In some examples, the set of performance indicators may be indicative of (i) a configuration speed indicator indicative of a speed (e.g., average speed) with which a reputation decision process is performed using the decision gate control configuration 118 to determine a reputation decision (e.g., the first reputation decision 146) associated with a content item and/or a duration of time (e.g., average duration of time) it takes for the reputation decision process to be performed, (ii) a false positive rate (e.g., the false positive rate may correspond to a rate with which performing reputation decision processes using the decision gate control configuration 118 result in decision results that falsely indicate at least one of a malicious finding, a phishing finding, etc.), (iii) a false negative rate (e.g., the false negative rate may correspond to a rate with which performing reputation decision processes using the decision gate control configuration 118 result in decision results that falsely indicate a clean finding), (iv) an unknown verdict rate (e.g., the unknown verdict rate may correspond to a rate with which performing reputation decision processes using the decision gate control configuration 118 result in decision results indicative of inconclusive findings), and/or (v) other information.

In some examples, a self-learning module 134 may be configured to use the set of performance indicators 128 to (i) evaluate performance of the decision gate control configuration 118 and/or (ii) generate the updated decision gate control configuration 136. In some examples, the self-learning module 134 may use a third machine learning model to generate the updated decision gate control configuration 136. For example, the third machine learning model may be trained to (i) make adjustments to the decision gate control configuration 118 to generate the updated decision gate control configuration 136, (ii) group decision gates into groups and/or (iii) order and/or arrange decision gates and/or groups of decision gates.

In some examples, the self-learning module 134 may evaluate performance of the decision gate control configuration 118 by applying a fitness function to the set of performance indicators 128. In some examples, the fitness function may comprise one or more weights for configuring an importance of a performance indicator (e.g., at least one of the false positive rate, the false negative rate, the unknown verdict rate, the configuration speed indicator, etc.). In an example, the fitness function may be F=a×FPR+b×FNR+c×UR+d×DURATION, where FPR corresponds to the false positive rate, FNR corresponds to the false negative rate, UR corresponds to the unknown verdict rate, DURATION corresponds to the configuration speed indicator, a, b, c and/or d are weights for configuring importance associated with performance indicators of the set of performance indicators 128. In some examples, the self-learning module 134 may perform, based upon the fitness function and/or the set of performance indicators 128, an optimization task to generate the updated decision gate control configuration 136. In some examples, the updated decision gate control configuration 136 may be an optimized configuration that reduces and/or minimizes a loss F of the fitness function. In some examples, the fitness function and/or one or more weights of the fitness function may be determined using one or more evolutionary models and/or algorithms (e.g., genetic models and/or algorithms).

In some examples, the self-learning module 134 may adjust one or more weights of the fitness function to adjust an impact of a performance indicator on the loss F. In an example, the self-learning module 134 may adjust weight a to adjust an impact of the false positive rate on the loss F of the fitness function. For example, the self-learning module 134 may increase weight a to increase the impact of the false positive rate on the loss F of the fitness function, thereby resulting in the self-learning module 134 placing more importance on reducing and/or minimizing false positives determined by the updated decision gate control configuration 136. Alternatively and/or additionally, the self-learning module 134 may decrease weight a to decrease the impact of the false positive rate on the loss F of the fitness function, thereby resulting in the self-learning module 134 placing less importance on reducing and/or minimizing false positives determined by the updated decision gate control configuration 136.

Alternatively and/or additionally, the self-learning module 134 may adjust weight b to adjust an impact of the false negative rate on the loss F of the fitness function. For example, the self-learning module 134 may increase weight b to increase the impact of the false negative rate on the loss F of the fitness function, thereby resulting in the self-learning module 134 placing more importance on reducing and/or minimizing false negatives determined by the updated decision gate control configuration 136. Alternatively and/or additionally, the self-learning module 134 may decrease weight b to decrease the impact of the false negative rate on the loss F of the fitness function, thereby resulting in the self-learning module 134 placing less importance on reducing and/or minimizing false negatives determined by the updated decision gate control configuration 136.

In some examples, the self-learning module 134 may adjust one or more weights (e.g., at least one of weight a, weight b, etc.) to achieve a target ratio of false positives to false negatives. In some examples, the target ratio may be a predefined value (e.g., the self-learning module 134 may retrieve the target ratio from memory).

Alternatively and/or additionally, the self-learning module 134 may adjust weight c to adjust an impact of the unknown verdict rate on the loss F of the fitness function. For example, the self-learning module 134 may increase weight c to increase the impact of the unknown verdict rate on the loss F of the fitness function, thereby resulting in the self-learning module 134 placing more importance on reducing and/or minimizing unknown verdicts output using the updated decision gate control configuration 136. Alternatively and/or additionally, the self-learning module 134 may decrease weight c to decrease the impact of the unknown verdict rate on the loss F of the fitness function, thereby resulting in the self-learning module 134 placing less importance on reducing and/or minimizing unknown verdicts output using the updated decision gate control configuration 136.

Alternatively and/or additionally, the self-learning module 134 may adjust weight d to adjust an impact of the configuration speed indicator on the loss F of the fitness function. For example, the self-learning module 134 may increase weight d to increase the impact of the configuration speed indicator on the loss F of the fitness function, thereby resulting in the self-learning module 134 placing more importance on reducing and/or minimizing a time it takes to execute the updated decision gate control configuration 136 to determine a reputation decision. Alternatively and/or additionally, the self-learning module 134 may decrease weight d to decrease the impact of the configuration speed indicator on the loss F of the fitness function, thereby resulting in the self-learning module 134 placing less importance on reducing and/or minimizing a time it takes to execute the updated decision gate control configuration 136 to determine a reputation decision.

In some examples, the usage information 124 may be provided to a decision gate profile update module 130. The usage information 124 may be indicative of timing information associated with execution of decision gates of the decision gate control configuration 118. The decision gate profile update module 130 may use the usage information 124 to determine updated values of one or more decision gate profiles, and/or may access the decision gate profile data store 132 (e.g., a database) to adjust the one or more decision gate profiles based upon the updated values. For example, the decision gate profile update module 130 may use the timing information indicated by the usage information 124 to determine an updated version of the first speed indicator of the first decision gate profile 102 associated with the first decision gate DG1. In response to determining the updated version of the first speed indicator, the decision gate profile update module 130 may access the decision gate profile data store 132 to modify the first decision gate profile 102 to include the updated version of the first speed indicator.

In some examples, the self-learning module 134 may make one or more adjustments to the decision gate control configuration 118 based upon the set of performance indicators 128 and/or the fitness function to generate the updated decision gate control configuration 136. For example, the one or more adjustments may comprise (i) rearranging one or more decision gates of the decision gate control configuration 118, (ii) modifying one or more conditions associated with a connection line between decision gates and/or groups of decision gates (e.g., modifying the one or more first conditions associate with the connection line C1), (iii) removing a decision gate from the decision gate control configuration 118 such that the updated decision gate control configuration 136 does not comprise the decision gate, (iv) adding, to the updated decision gate control configuration 136, a supplemental decision gate that was not included in the decision gate control configuration 118, (v) removing a group of decision gates from the decision gate control configuration 118 such that the updated decision gate control configuration 136 does not comprise the group of decision gates, (vi) adding, to the updated decision gate control configuration 136, a supplemental group of decision gates that was not included in the decision gate control configuration 118, (vii) modifying one or more decision weights (e.g., at least one of the first gate decision weight, the second gate decision weight, the third gate decision weight, the first group decision weight, the second group decision weight, etc.) and/or (viii) one or more other adjustments. In this way, a closed-loop process is implemented allowing usage of logged information (e.g., the usage information 124) to tailor a decision gate control configuration (e.g., at least one of the decision gate control configuration 118, the updated decision gate control configuration 136, etc.) used by the reputation decision determination module 144 to determine reputation decisions. For example, the self-learning module 134 may be configured to periodically (and/or in an aperiodic manner) configure the reputation decision determination module 144 with updated versions of the decision gate control configuration, thereby improving (e.g., continuously and/or periodically improving over time) a quality and/or accuracy of reputation decisions determined using the reputation decision determination module 144. Closed-loop control may reduce errors and produce more efficient operation of a computer system which implements the reputation decision determination module 144. The reduction of errors and/or the efficient operation of the computer system may improve operational stability and/or predictability of operation. Accordingly, using processing circuitry to implement closed-loop control described herein may improve operation of underlying hardware of the computer system.

In some examples, the updated decision gate control configuration 136 may be used for determining reputation decisions associated with content items. In some examples, the updated decision gate control configuration 136 may provide more accurate reputation decisions as compared with the decision gate control configuration 118, such as due, at least in part, to the one or more adjustments made by the self-learning module 134 to the decision gate control configuration 118 based upon the set of performance indicators 128 and/or the fitness function to generate the updated decision gate control configuration 136. For example, the reputation decision determination module 144 may be configured 137 with the updated decision gate control configuration 136 (e.g., the updated decision gate control configuration 136 may be provided to and/or installed on the reputation decision determination module 144).

In some examples, a second reputation decision process associated with a second content item may be performed using the updated decision gate control configuration 136 to determine a second reputation decision associated with the second content item. In an example, the second reputation decision process may be triggered in response to receiving a request associated with the second content item. Alternatively and/or additionally, the second reputation decision process may be triggered automatically in response to determining that one or more conditions associated with the second content item are met. Alternatively and/or additionally, the second reputation decision process may be performed as part of a reputation monitoring service that executes reputation decision processes for the second content item in a periodic and/or aperiodic manner. In some examples, the reputation decision determination module 144 may perform the second reputation decision process (using the updated decision gate control configuration 136) to determine the second reputation decision using one or more of the techniques provided herein with respect to performing the first reputation decision process (using the decision gate control configuration 118) to determine the first reputation decision 146. In some examples, the second reputation decision may be applied (using the reputation decision application module 148, for example), such as using one or more of the techniques provided herein with respect to applying the first reputation decision 146. For example, the reputation decision application module 148 may control access to the second content item and/or a second resource (e.g., an internet resource such as a second web page) associated with the second content item based upon the second reputation decision. Alternatively and/or additionally, the reputation decision application module 148 may transmit an indication of the second reputation decision to the threat protection device, which may be configured to control access to the second content item and/or the second resource.

In some examples, the configuration generation model 116 may be configured to generate the decision gate control configuration 118 using the fitness function. In some examples, the configuration generation model 116 may perform, based upon the fitness function, an optimization task to generate the decision gate control configuration 118. In some examples, the decision gate control configuration 118 may be an optimized configuration that reduces and/or minimizes the loss F of the fitness function.

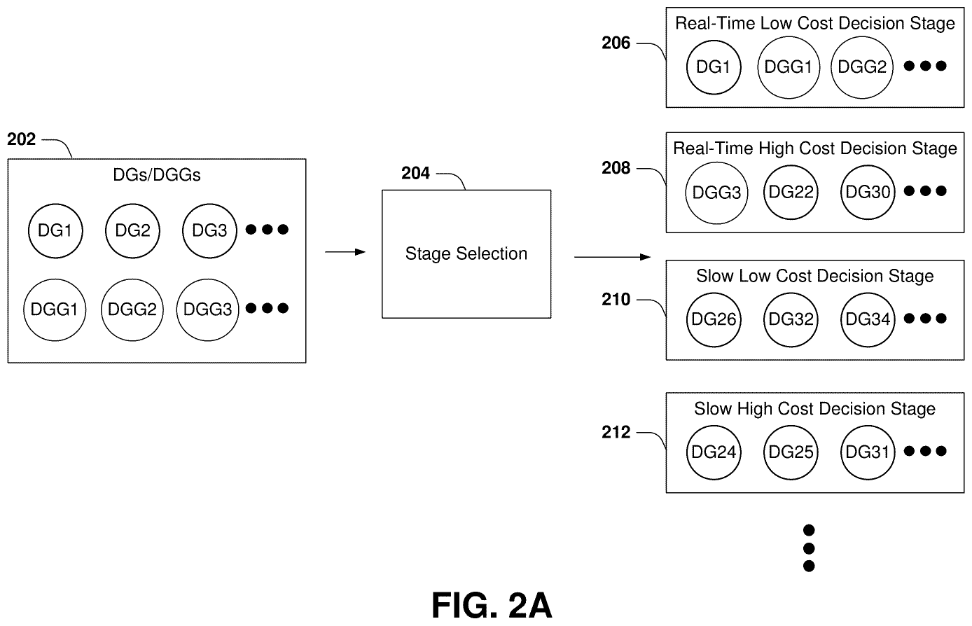

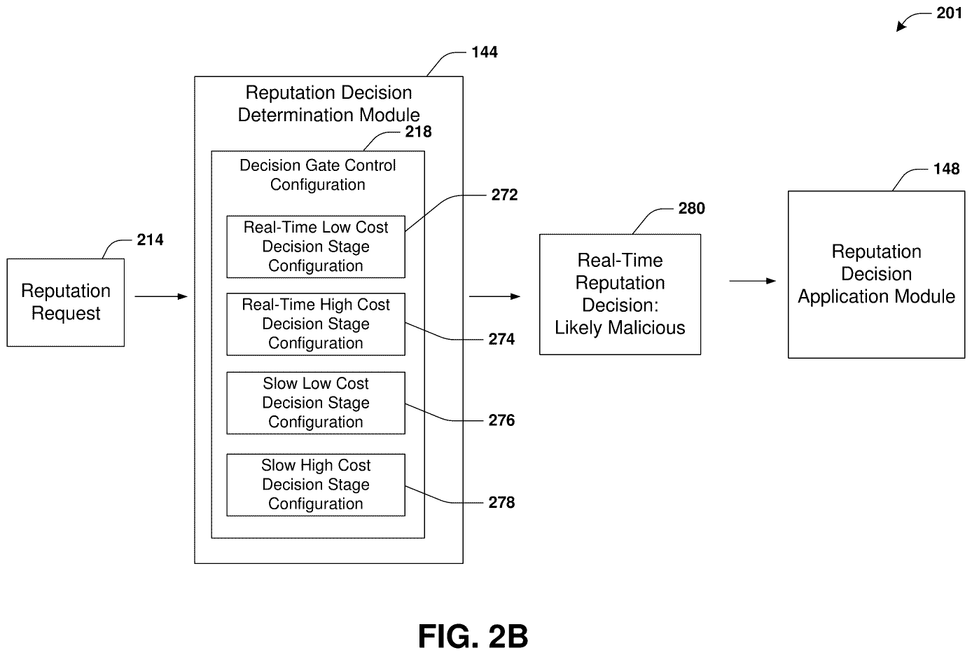

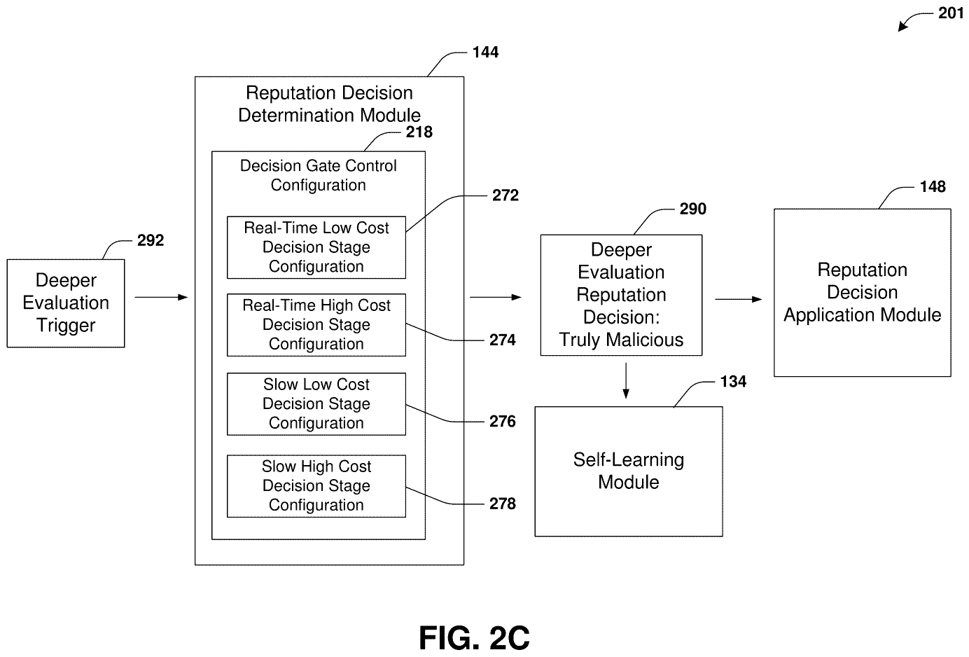

FIGS. 2A-2C illustrate examples of a system 201 (e.g., a decision gate control system) in which the reputation decision determination module 144 uses a multi-stage decision gate control configuration 218 (shown in FIG. 2A) to determine a reputation decision associated with a content item. In some examples, the multi-stage decision gate control configuration 218 may comprise at least one of the decision gate control configuration 118, the updated decision gate control configuration 136, etc. The multi-stage decision gate control configuration 218 may be generated (using the configuration generation model 116, for example) using one or more of the techniques provided herein with respect to generating the decision gate control configuration 118. The multi-stage decision gate control configuration 218 may be dynamically updated (using the self-learning module 134, for example) using one or more of the techniques provided herein with respect to updating the decision gate control configuration 118 to generate the updated decision gate control configuration 136.

FIG. 2A illustrates a stage selection process 204 performed to select decision gates and/or groups of decision gates for inclusion in stages associated with the multi-stage decision gate control configuration 218. In some examples, the stage selection process 204 may be performed by the configuration generation model 116 and/or the self-learning module 134. The decision gates and/or groups of decision gates may be selected from a collection 202 comprising decision gates of the first plurality of decision gates 114 and/or groups of decision gates of the plurality of groups 140. In some examples, the stage selection process 204 may be performed based upon the first plurality of decision gate profiles 112. For example, the stage selection process 204 may be performed based upon cost indicators and/or speed indicators (and/or other information, such as output types and/or value indicators) associated with the decision gates.

In an example, a first set of decision gates and/or groups 206 may be selected from the collection 202 for execution in a first stage (e.g., a real-time low cost decision stage) associated with the multi-stage decision gate control configuration 218. The first decision gate DG1 of the first set of decision gates and/or groups 206 may be selected for execution in the first stage based upon (i) the first speed indicator associated with the first decision gate DG1 meeting a first speed indicator threshold (e.g., a speed with which the first decision gate DG1 is executed is faster than a speed indicated by the first speed indicator threshold), (ii) the first cost indicator associated with the first decision gate DG1 not meeting a first cost indicator threshold (e.g., a cost of executing the first decision gate DG1 is less than a cost indicated by the first cost indicator threshold), and/or (iii) one or more conditions associated with the first value indicator and/or the first output type being met. In an example, the first set of decision gates and/or groups 206 may comprise a decision gate associated with performing the content item whitelist lookup process, a decision gate associated with performing the content item blacklist lookup process, a decision gate associated with performing the domain whitelist lookup process, a decision gate associated with performing the domain blacklist lookup process, and/or decision gates associated with one or more other (relatively fast and/or low cost, for example) reputation decision processes. The first set of decision gates and/or groups 206 may be selected for execution in the first stage based upon shared characteristics between the first set of decision gates and/or groups 206, such as the same (and/or similar) costs and/or the same (and/or similar) speeds).

A second set of decision gates and/or groups 208 may be selected from the collection 202 for execution in a second stage (e.g., a real-time high cost decision stage) associated with the multi-stage decision gate control configuration 218. A decision gate DG22 of the second set of decision gates and/or groups 208 may be selected for execution in the second stage based upon (i) a speed indicator associated with the decision gate DG22 meeting the first speed indicator threshold (e.g., a speed with which the decision gate DG22 is executed is faster than a speed indicated by the first speed indicator threshold), (ii) a cost indicator associated with the decision gate DG22 meeting the first cost indicator threshold (e.g., a cost of executing the decision gate DG22 is greater than a cost indicated by the first cost indicator threshold), and/or (iii) one or more conditions associated with a value indicator and/or an output type associated with the decision gate DG22 being met. In an example, the second set of decision gates and/or groups 208 may comprise a decision gate associated with performing the strategic vendor process, and/or decision gates associated with one or more other (relatively fast and/or high cost, for example) reputation decision processes. The second set of decision gates and/or groups 208 may be selected for execution in the second stage based upon shared characteristics between the second set of decision gates and/or groups 208, such as the same (and/or similar) costs and/or the same (and/or similar) speeds).

A third set of decision gates and/or groups 210 may be selected from the collection 202 for execution in a third stage (e.g., a slow low cost decision stage) associated with the multi-stage decision gate control configuration 218. A decision gate DG26 of the third set of decision gates and/or groups 210 may be selected for execution in the third stage based upon (i) a speed indicator associated with the decision gate DG26 not meeting the first speed indicator threshold (e.g., a speed with which the decision gate DG26 is executed is slower than a speed indicated by the first speed indicator threshold), (ii) a cost indicator associated with the decision gate DG26 not meeting the first cost indicator threshold (e.g., a cost of executing the decision gate DG26 is less than a cost indicated by the first cost indicator threshold), and/or (iii) one or more conditions associated with a value indicator and/or an output type associated with the decision gate DG26 being met. In an example, the third set of decision gates and/or groups 210 may comprise a decision gate associated with performing the deep analysis process, and/or decision gates associated with one or more other (relatively slow and/or low cost, for example) reputation decision processes. The third set of decision gates and/or groups 210 may be selected for execution in the third stage based upon shared characteristics between the third set of decision gates and/or groups 210, such as the same (and/or similar) costs and/or the same (and/or similar) speeds).

A fourth set of decision gates and/or groups 212 may be selected from the collection 202 for execution in a fourth stage (e.g., a slow high cost decision stage) associated with the multi-stage decision gate control configuration 218. A decision gate DG24 of the fourth set of decision gates and/or groups 212 may be selected for execution in the fourth stage based upon (i) a speed indicator associated with the decision gate DG24 not meeting the first speed indicator threshold (e.g., a speed with which the decision gate DG24 is executed is slower than a speed indicated by the first speed indicator threshold), (ii) a cost indicator associated with the decision gate DG24 meeting the first cost indicator threshold (e.g., a cost of executing the decision gate DG24 is greater than a cost indicated by the first cost indicator threshold), and/or (iii) one or more conditions associated with a value indicator and/or an output type associated with the decision gate DG24 being met. In an example, the fourth set of decision gates and/or groups 212 may comprise a decision gate associated with performing the expert analysis process, and/or decision gates associated with one or more other (relatively slow and/or high cost, for example) reputation decision processes. The fourth set of decision gates and/or groups 212 may be selected for execution in the fourth stage based upon shared characteristics between the fourth set of decision gates and/or groups 212, such as the same (and/or similar) costs and/or the same (and/or similar) speeds).

In some examples, the multi-stage decision gate control configuration 218 may be used to perform reputation decision processes to determine reputation decisions associated with content items. In an example scenario shown in FIG. 2B, a third reputation decision process for determining one or more reputation decisions associated with a third content item may be triggered in response to receiving a request 214 associated with the third content item. Alternatively and/or additionally, the third reputation decision process may be triggered automatically in response to determining that one or more conditions associated with the third content item are met. Alternatively and/or additionally, the third reputation decision process may be performed as part of a reputation monitoring service that executes reputation decision processes for the third content item in a periodic and/or aperiodic manner.

In some examples, the third content item may comprise at least one of a URL, a file, an email, a video, or other type of content. In some examples, the third reputation decision process may be performed using the reputation decision determination module 144. For example, the reputation decision determination module 144 may execute decision gates of the multi-stage decision gate control configuration 218 in accordance with an arrangement and/or flow configured by the multi-stage decision gate control configuration 218.

In some examples, the multi-stage decision gate control configuration 218 may comprise a first stage decision gate control configuration 272 associated with the first stage, a second stage decision gate control configuration 274 associated with the second stage, a third stage decision gate control configuration 276 associated with the third stage and/or a fourth stage decision gate control configuration 278 associated with the fourth stage. In some examples, the first stage decision gate control configuration 272 may comprise a first graph (e.g., a first DAG and/or other type of graph) with nodes corresponding to decision gates and/or groups of the first set of decision gates and/or groups 206 and/or connection lines between the nodes (e.g., the connection lines may be used to indicate at least one of flow direction between decision gates, one or more dependencies and/or conditions associated with decision gates, etc.). The second stage decision gate control configuration 274 may comprise a second graph (e.g., a second DAG and/or other type of graph) with nodes corresponding to decision gates and/or groups of the second set of decision gates and/or groups 208 and/or connection lines between the nodes. The third stage decision gate control configuration 276 may comprise a third graph (e.g., a third DAG and/or other type of graph) with nodes corresponding to decision gates and/or groups of the third set of decision gates and/or groups 210 and/or connection lines between the nodes. The fourth stage decision gate control configuration 278 may comprise a fourth graph (e.g., a fourth DAG and/or other type of graph) with nodes corresponding to decision gates and/or groups of the fourth set of decision gates and/or groups 212 and/or connection lines between the nodes. The first stage decision gate control configuration 272, the second stage decision gate control configuration 274, the third stage decision gate control configuration 276 and/or the fourth stage decision gate control configuration 278 may be generated and/or configured using one or more of the techniques provided herein with respect to generating and/or configuring the decision gate control configuration 118.

In some examples, the reputation decision determination module 144 may perform one or more first reputation decision stages to determine a third reputation decision 280 associated with the third content item and/or a third confidence score associated with the third reputation decision 280. In an example, the third reputation decision 280 may be a real-time decision. For example, the one or more first reputation decision stages performed to determine the third reputation decision 280 may comprise one or more stages (e.g., the first stage and/or the second stage) that involve decision gates with relatively quick speeds for real-time and/or immediate results.

In some examples, the reputation decision determination module 144 may perform the first stage to determine a first stage reputation decision and/or a first stage confidence score associated with the first stage reputation decision. For example, the reputation decision determination module 144 may execute decision gates and/or groups of decision gates of the first stage decision gate control configuration 272 in accordance with an arrangement and/or flow configured by the first stage decision gate control configuration 272 to determine a first set of reputation decisions (comprising group reputation decisions and/or gate reputation decisions, for example). For example, the decision gates and/or groups of decision gates executed by the reputation decision determination module 144 to determine the first set of reputation decisions may comprise some and/or all decision gates and/or groups of the first set of decision gates and/or groups 206. In some examples, the reputation decision determination module 144 may determine the first stage reputation decision associated with the third content item based upon the first set of reputation decisions (using one or more of the techniques provided herein with respect to determining the first reputation decision 146 associated with the first content item based upon the set of reputation decisions, for example). In some examples, the first stage confidence score associated with the first stage reputation decision may be determined based upon the first set of reputation decisions (using one or more of the techniques provided herein with respect to determining the first confidence score associated with the first reputation decision 146, for example).

In some examples, the reputation decision determination module 144 may perform the second stage to determine a second stage reputation decision and/or a second stage confidence score associated with the second stage reputation decision. For example, the reputation decision determination module 144 may execute decision gates and/or groups of decision gates of the second stage decision gate control configuration 274 in accordance with an arrangement and/or flow configured by the second stage decision gate control configuration 274 to determine a second set of reputation decisions (comprising group reputation decisions and/or gate reputation decisions, for example). For example, the decision gates and/or groups of decision gates executed by the reputation decision determination module 144 to determine the second set of reputation decisions may comprise some and/or all decision gates and/or groups of the second set of decision gates and/or groups 208. In some examples, the reputation decision determination module 144 may determine the second stage reputation decision associated with the third content item based upon the second set of reputation decisions (using one or more of the techniques provided herein with respect to determining the first reputation decision 146 associated with the first content item based upon the set of reputation decisions, for example). In some examples, the second stage confidence score associated with the second stage reputation decision may be determined based upon the second set of reputation decisions (using one or more of the techniques provided herein with respect to determining the first confidence score associated with the first reputation decision 146, for example).

In some examples, the reputation decision determination module 144 may determine the third reputation decision 280 based upon the first stage reputation decision associated with the first stage and/or the second stage reputation decision associated with the second stage. In some examples, the first stage and the second stage may be performed concurrently. Alternatively and/or additionally, the first stage and the second stage may be performed separately and/or in different time periods.

In some examples, after determining the first stage reputation decision, the reputation decision determination module 144 may determine whether to perform the second stage based upon the first stage reputation decision and/or the first stage confidence score. In some examples, the reputation decision determination module 144 may determine not to perform the second stage based upon a determination that the first stage confidence score meets a first confidence score threshold (e.g., the first stage confidence score is greater than the first confidence score threshold). For example, in response to determining that the first stage confidence score meets the first confidence score threshold, the reputation decision determination module 144 may provide the first stage reputation decision (as the third reputation decision 280) to the reputation decision application module 148 without performing the second stage. In some examples, the reputation decision determination module 144 may determine to perform the second stage based upon a determination that the first stage confidence score does not meet the first confidence score threshold (e.g., the first stage confidence score is less than the first confidence score threshold). For example, in response to determining that the first stage confidence score does not meet the first confidence score threshold, the reputation decision determination module 144 may (i) perform the second stage to determine the second stage reputation decision, (ii) determine the third reputation decision 280 based upon the first stage reputation decision and/or the second stage reputation decision, and/or (iii) provide the third reputation decision 280 (that is based upon the first stage reputation decision and/or the second stage reputation decision, for example) to the reputation decision application module 148.

In some examples, in response to the reputation decision determination module 144 providing the third reputation decision 280 to the reputation decision application module 148, the reputation decision application module 148 may apply the third reputation decision 280 during a first period of time, such as using one or more of the techniques provided herein with respect to applying the first reputation decision 146. For example, the reputation decision application module 148 may control access to the third content item and/or a third resource associated with the third content item based upon the third reputation decision 280. Alternatively and/or additionally, the reputation decision application module 148 may transmit an indication of the third reputation decision 280 to the threat protection device, which may be configured to control access to the third content item and/or the third resource. In some examples, during the first period of time, one or more first threat protection actions (e.g., the one or more threat protection actions 149) associated with the third content item and/or the third resource are performed (by the reputation decision application module 148 and/or the threat protection device) based upon the third reputation decision 280. In an example, the third reputation decision 280 may indicate that the third content item is “likely malicious”.

In some examples, based upon the third reputation decision 280 indicating a potential threat (e.g., a malicious finding, a phishing finding and/or a malware finding and/or other finding associated with a potential threat), the one or more first threat protection actions may include restricting, blocking, limiting and/or obstructing access of one or more entities (e.g., users of a threat protection service) to the third content item and/or the third resource, which may (i) protect the one or more entities from potential threats such as phishing schemes, malware, a hacking attempt, etc., and/or (ii) reduce bandwidth used by the one or more entities as a result of restricting transmission of malicious content. Alternatively and/or additionally, based upon the third reputation decision 280 indicating a potential threat, the one or more first threat protection actions may include (i) blocking the third content item and/or the third resource associated with the third content item from being stored and/or opened in a vulnerable environment, and/or (ii) storing and/or opening the third content item and/or the third resource in a secure environment, such as a sandbox and/or other type of environment, thereby protecting the vulnerable environment from potential threats such as malware, a hacking attempt, etc. Alternatively and/or additionally, based upon the third reputation decision 280 indicating a potential threat, the one or more first threat protection actions may include removing the third content item and/or the third resource from a content platform that hosts the third content item and/or the third resource.

In an example, the third resource may comprise a third web page and/or the third content item may comprise a URL (and/or a domain and/or other type of identifier) associated with the third web page. Based upon the third reputation decision 280 indicating a malicious finding, a phishing finding and/or a malware finding (and/or other finding associated with a potential threat), the one or more first threat protection actions may include providing a first threat detection alert (e.g., the threat protection alert 182 shown in FIG. 1F) to a client device in response to determining that the client device attempted to access the third web page. In some examples, the reputation decision determination module 144 may determine the third reputation decision 280 and/or provide the third reputation decision 280 to the reputation decision application module 148 in response to determining that the client device attempted to access the third web page. In an example, a threat protection tool may transmit the request 214 associated with the third content item to the reputation decision determination module 144 in response to detecting the client device attempting to access the third web page.

In some examples, based upon the third reputation decision 280 indicating a clean finding, the reputation decision application module 148 and/or the threat protection device may provide one or more users with access (e.g., unimpeded access) to the third content item and/or the third resource (without providing a threat protection alert, for example).

In some examples, the reputation decision determination module 144 may perform one or more second reputation decision stages to determine a fourth reputation decision 290 associated with the third content item and/or a fourth confidence score associated with the fourth reputation decision 290. In an example, the fourth reputation decision 290 may be a deeper evaluation decision that takes longer to determine than the third reputation decision 280 (e.g., the real-time decision). For example, the one or more second reputation decision stages performed to determine the fourth reputation decision 290 may comprise one or more stages (e.g., the third stage and/or the fourth stage) that involve decision gates with relatively slower speeds.

In an example scenario shown in FIG. 2C, the one or more second reputation decision stages may be performed in response to triggering 292 a deeper evaluation for the third content item. In some examples, the deeper evaluation may be triggered 292 based upon (i) a determination that the third confidence score (which may be determined based upon the first stage confidence score and/or the second stage confidence score, for example) associated with the third reputation decision 280 does not meet a second confidence score threshold (e.g., the third confidence score may be less than the second confidence score threshold) and/or (ii) a determination that an activity indicator associated with the third content item meets an activity indicator threshold (e.g., the third confidence score may be greater than the second confidence score threshold). In an example in which the third content item is a URL to a web page, the activity indicator may comprise a measure of page visits to the web page (e.g., the deeper evaluation may be triggered 292 in response to detecting more than a threshold quantity of page visits to the web page) and/or other measure of internet activity associated with the web page. Alternatively and/or additionally, the one or more second reputation decision stages may be performed as part of a deeper evaluation service that executes deeper evaluations for the third content item in a periodic and/or aperiodic manner.

In some examples, the reputation decision determination module 144 may perform the third stage to determine a third stage reputation decision and/or a third stage confidence score associated with the third stage reputation decision. For example, the reputation decision determination module 144 may execute decision gates and/or groups of decision gates of the third stage decision gate control configuration 276 in accordance with an arrangement and/or flow configured by the third stage decision gate control configuration 276 to determine a third set of reputation decisions (comprising group reputation decisions and/or gate reputation decisions, for example). For example, the decision gates and/or groups of decision gates executed by the reputation decision determination module 144 to determine the third set of reputation decisions may comprise some and/or all decision gates and/or groups of the third set of decision gates and/or groups 210. In some examples, the reputation decision determination module 144 may determine the third stage reputation decision associated with the third content item based upon the third set of reputation decisions (using one or more of the techniques provided herein with respect to determining the first reputation decision 146 associated with the first content item based upon the set of reputation decisions, for example). In some examples, the third stage confidence score associated with the third stage reputation decision may be determined based upon the third set of reputation decisions (using one or more of the techniques provided herein with respect to determining the first confidence score associated with the first reputation decision 146, for example).

In some examples, the reputation decision determination module 144 may perform the fourth stage to determine a fourth stage reputation decision and/or a fourth stage confidence score associated with the fourth stage reputation decision. For example, the reputation decision determination module 144 may execute decision gates and/or groups of decision gates of the fourth stage decision gate control configuration 278 in accordance with an arrangement and/or flow configured by the fourth stage decision gate control configuration 278 to determine a fourth set of reputation decisions (comprising group reputation decisions and/or gate reputation decisions, for example). For example, the decision gates and/or groups of decision gates executed by the reputation decision determination module 144 to determine the fourth set of reputation decisions may comprise some and/or all decision gates and/or groups of the fourth set of decision gates and/or groups 212. In some examples, the reputation decision determination module 144 may determine the fourth stage reputation decision associated with the third content item based upon the fourth set of reputation decisions (using one or more of the techniques provided herein with respect to determining the first reputation decision 146 associated with the first content item based upon the set of reputation decisions, for example). In some examples, the fourth stage confidence score associated with the fourth stage reputation decision may be determined based upon the fourth set of reputation decisions (using one or more of the techniques provided herein with respect to determining the first confidence score associated with the first reputation decision 146, for example).

In some examples, the reputation decision determination module 144 may determine the fourth reputation decision 290 based upon the third stage reputation decision associated with the third stage and/or the fourth stage reputation decision associated with the fourth stage. In some examples, the third stage and the fourth stage may be performed concurrently. Alternatively and/or additionally, the third stage and the fourth stage may be performed separately and/or in different time periods.

In some examples, after determining the third stage reputation decision, the reputation decision determination module 144 may determine whether to perform the fourth stage based upon the third stage reputation decision and/or the third stage confidence score. In some examples, the reputation decision determination module 144 may determine not to perform the fourth stage based upon a determination that the third stage confidence score meets a third confidence score threshold (e.g., the third stage confidence score is greater than the third confidence score threshold). For example, in response to determining that the third stage confidence score meets the third confidence score threshold, the reputation decision determination module 144 may provide the third stage reputation decision (as the fourth reputation decision 290) to the reputation decision application module 148 without performing the fourth stage. In some examples, the reputation decision determination module 144 may determine to perform the fourth stage based upon a determination that the third stage confidence score does not meet the third confidence score threshold (e.g., the third stage confidence score is less than the third confidence score threshold). For example, in response to determining that the third stage confidence score does not meet the third confidence score threshold, the reputation decision determination module 144 may (i) perform the fourth stage to determine the fourth stage reputation decision, (ii) determine the fourth reputation decision 290 based upon the third stage reputation decision and/or the fourth stage reputation decision, and/or (iii) provide the fourth reputation decision 290 (that is based upon the third stage reputation decision and/or the fourth stage reputation decision, for example) to the reputation decision application module 148.

In some examples, in response to the reputation decision determination module 144 providing the fourth reputation decision 290 to the reputation decision application module 148, the reputation decision application module 148 may apply the fourth reputation decision 290 during a second period of time (after the first period of time, for example), such as using one or more of the techniques provided herein with respect to applying the first reputation decision 146. For example, the reputation decision application module 148 may control access to the third content item based upon the fourth reputation decision 290. Alternatively and/or additionally, the reputation decision application module 148 may transmit an indication of the fourth reputation decision 290 to the threat protection device, which may be configured to control access to the third content item and/or the third resource. In some examples, during the second period of time, one or more second threat protection actions (e.g., the one or more threat protection actions 149) associated with the third content item and/or the third resource are performed (by the reputation decision application module 148 and/or the threat protection device) based upon the fourth reputation decision 290.

In some examples, based upon the fourth reputation decision 290 indicating a potential threat (e.g., a malicious finding, a phishing finding and/or a malware finding and/or other finding associated with a potential threat), the one or more second threat protection actions may include restricting, blocking, limiting and/or obstructing access of one or more entities (e.g., users of a threat protection service) to the third content item and/or the third resource, which may (i) protect the one or more entities from potential threats such as phishing schemes, malware, a hacking attempt, etc., and/or (ii) reduce bandwidth used by the one or more entities as a result of restricting transmission of malicious content. Alternatively and/or additionally, based upon the fourth reputation decision 290 indicating a potential threat, the one or more second threat protection actions may include (i) blocking the third content item and/or the third resource associated with the third content item from being stored and/or opened in a vulnerable environment, and/or (ii) storing and/or opening the third content item and/or the third resource in a secure environment, such as a sandbox and/or other type of environment, thereby protecting the vulnerable environment from potential threats such as malware, a hacking attempt, etc. Alternatively and/or additionally, based upon the fourth reputation decision 290 indicating a potential threat, the one or more second threat protection actions may include removing the third content item and/or the third resource from a content platform that hosts the third content item and/or the third resource.

In an example, the third resource may comprise the third web page and/or the third content item may comprise the URL (and/or the domain and/or other type of identifier) associated with the third web page. Based upon the fourth reputation decision 290 indicating a malicious finding, a phishing finding and/or a malware finding (and/or other finding associated with a potential threat), the one or more second threat protection actions may include providing a second threat detection alert (e.g., the threat protection alert 182 shown in FIG. 1F) to a client device in response to determining that the client device attempted to access the third web page.

In some examples, based upon the fourth reputation decision 290 indicating a clean finding, the reputation decision application module 148 and/or the threat protection device may provide one or more users with access (e.g., unimpeded access) to the third content item and/or the third resource (without providing a threat protection alert, for example).

In an example, the fourth reputation decision 290 may indicate that the third content item is “truly malicious”, which may be associated with a greater threat level than the third reputation decision 280 (e.g., “likely malicious”). Accordingly, the one or more second threat protection actions may be different than the one or more first threat protection actions. In an example, based upon the greater threat level associate with the fourth reputation decision 290 relative to the third reputation decision 280, the first threat detection alert may be generated to include the mark safe selectable input 186 and/or the unblock selectable input 188 and the second threat detection alert may be generated to not include the mark safe selectable input 186 and/or the unblock selectable input 188.

In some examples, the fourth reputation decision 290 may be provided to the self-learning module 134. In some examples, the self-learning module 134 may make one or more adjustments to the multi-stage decision gate control configuration 218 based upon the fourth reputation decision 290 to generate an updated version of the multi-stage decision gate control configuration 218. For example, the updated version of the multi-stage decision gate control configuration 218 may be subsequently used to determine decisions, such as real-time decisions, more accurately. For example, the one or more adjustments may comprise adjustments to first stage decision gate control configuration 272 and/or the second stage decision gate control configuration 274 (e.g., the adjustments may comprise at least one of rearranging one or more decision gates of the first stage decision gate control configuration 272 and/or the second stage decision gate control configuration 274, modifying connection lines of the first stage decision gate control configuration 272 and/or the second stage decision gate control configuration 274, etc.), thereby improving (e.g., continuously and/or periodically improving over time) a quality and/or accuracy of real-time reputation decisions determined using the reputation decision determination module 144.

In some examples, a (single) group of the plurality of groups 140 may comprise decision gates comprising a decision gate associated with performing the content item whitelist lookup process, a decision gate associated with performing the content item blacklist lookup process, a decision gate associated with performing the domain whitelist lookup process and/or a decision gate associated with performing the domain blacklist lookup process. For example, the decision gates may be grouped together in the same group even though the decision gates may be associated with the different output types.

One, some and/or all machine learning models of the present disclosure (e.g., the first machine learning model, the second machine learning model, and/or the third machine learning model) may, for example, comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc.

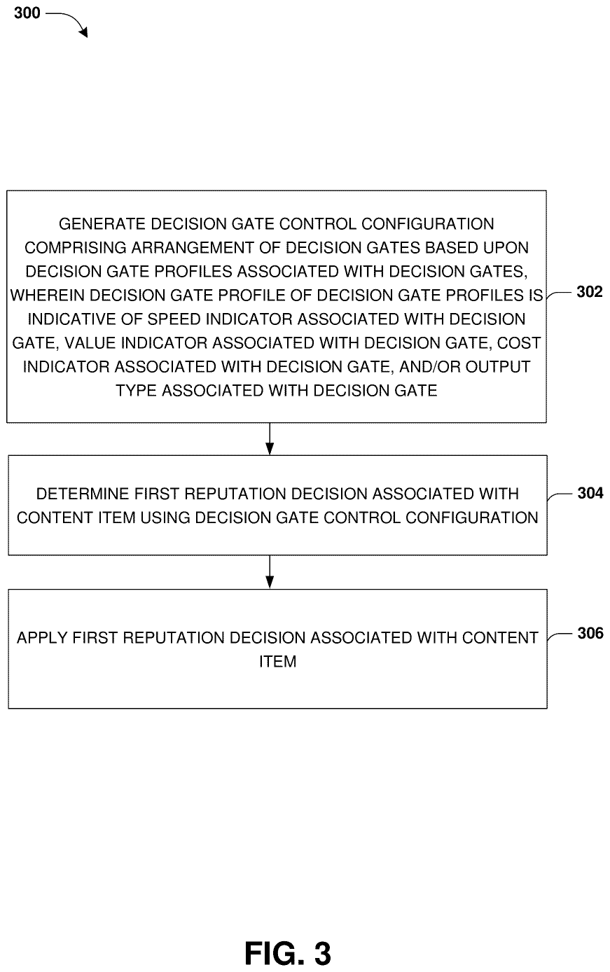

FIG. 3 illustrates an example method 300 for determining reputation decisions associated with content items, according to some embodiments. At 302, a decision gate control configuration (e.g., the decision gate control configuration 118, the updated decision gate control configuration 136 and/or the multi-stage decision gate control configuration 218) comprising an arrangement of decision gates may be generated based upon decision gate profiles (e.g., the first plurality of decision gate profiles 112) associated with the decision gates. A decision gate profile of the decision gate profiles may be indicative of a speed indicator associated with a decision gate, a value indicator associated with the decision gate, a cost indicator associated with the decision gate, and/or an output type associated with the decision gate. At 304, a first reputation decision (e.g., the first reputation decision 146, the third reputation decision 280, and/or the fourth reputation decision 290) associated with a content item may be determined using the decision gate control configuration. At 306, the first reputation decision associated with the content item may be applied.

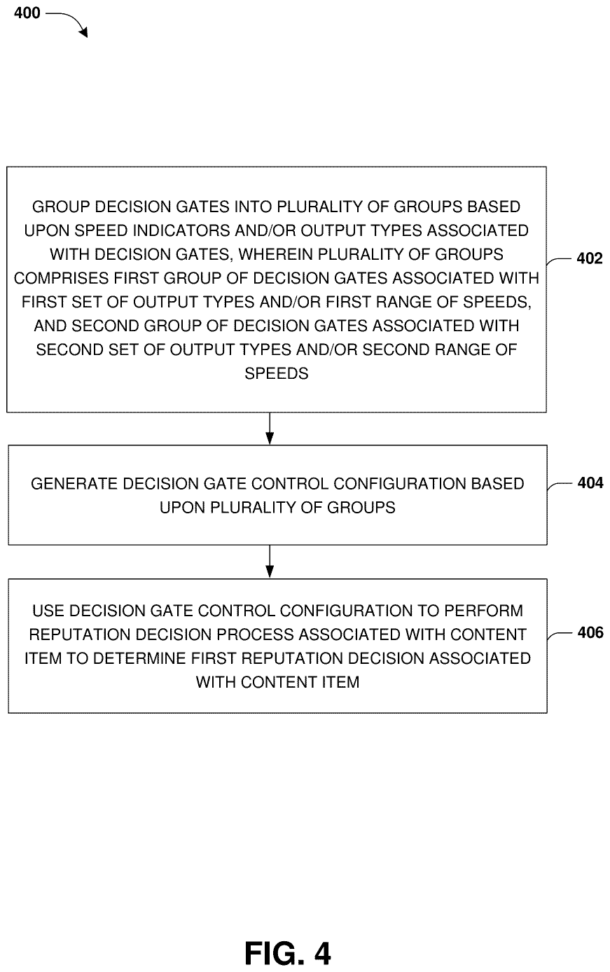

FIG. 4 illustrates an example method 400 for determining reputation decisions associated with content items, according to some embodiments. At 402, decision gates may be grouped into a plurality of groups (e.g., the plurality of groups 140) based upon speed indicators and/or output types associated with the decision gates. The plurality of groups may comprise (i) a first group of decision gates associated with at a first set of output types and/or a first speed indicator range and/or (ii) a second group of decision gates associated with a second set of output types and/or a second speed indicator range. At 404, a decision gate control configuration (e.g., the decision gate control configuration 118, the updated decision gate control configuration 136 and/or the multi-stage decision gate control configuration 218) may be generated based upon the plurality of groups. At 406, the decision gate control configuration may be used to perform a reputation decision process associated with a content item to determine a first reputation decision (e.g., the first reputation decision 146, the third reputation decision 280, and/or the fourth reputation decision 290) associated with the content item.

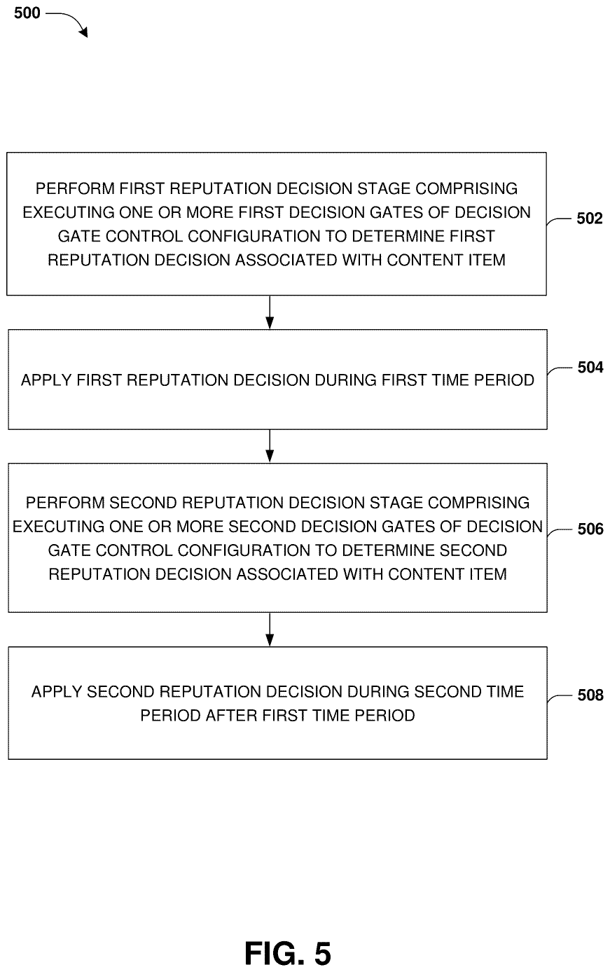

FIG. 5 illustrates an example method 500 for determining reputation decisions associated with content items, according to some embodiments. At 502, a first reputation decision stage may be performed. The first reputation decision stage may comprise executing one or more first decision gates of a decision gate control configuration to determine a first reputation decision (e.g., the third reputation decision 280) associated with a content item. At 504, the first reputation decision may be applied during a first time period. At 506, a second reputation decision stage may be performed. The second reputation decision stage may comprise executing one or more second decision gates of the decision gate control configuration to determine a second reputation decision (e.g., the fourth reputation decision 290) associated with the content item. At 508, the second reputation decision may be applied during a second time period after the first time period.

In some examples, at least some of the disclosed subject matter may be implemented on a client device, and in some examples, at least some of the disclosed subject matter may be implemented on a server (e.g., hosting a service accessible via a network, such as the Internet).

Implementation of at least some of the disclosed subject matter may lead to benefits including, but not limited to, a reduction in transmission of malicious content (and/or a reduction in bandwidth) (e.g., as a result of identifying malicious content and/or blocking access to the malicious content). Alternatively and/or additionally, implementation of at least some of the disclosed subject matter may lead to benefits including a reduction in instances that client devices are hacked and/or impacted by malicious content and/or activity. Alternatively and/or additionally, implementation of at least some of the disclosed subject matter may lead to benefits including reducing unauthorized access of client devices. Alternatively and/or additionally, implementation of at least some of the disclosed subject matter may lead to benefits including reduced manual effort associated with generating, updating and/or maintaining a decision gate control configuration (e.g., as a result of using the self-learning module 134 to automatically generate an updated decision gate control configuration).

In accordance with some embodiments, a method is provided. The method includes (i) performing a first reputation decision stage including executing one or more first decision gates of a decision gate control configuration to determine a first reputation decision associated with a content item, (ii) applying the first reputation decision during a first time period, (iii) performing a second reputation decision stage including executing one or more second decision gates of the decision gate control configuration to determine a second reputation decision associated with the content item, and (iv) applying the second reputation decision during a second time period after the first time period.

In some examples, the second reputation decision stage is performed in response to triggering a deeper evaluation for the content item.

In some examples, the deeper evaluation is triggered based upon (i) a confidence score associated with the first reputation decision not meeting a confidence score threshold, and/or (ii) an activity indicator associated with the content item meeting an activity indicator threshold.

In some examples, (i) applying the first reputation decision during the first time period includes controlling access to the content item and/or a resource associated with the content item based upon the first reputation decision during the first time period, and/or (ii) applying the second reputation decision during the second time period includes controlling access to the content item and/or the resource associated with the content item based upon the second reputation decision during the second time period.

In some examples, the method includes (i) logging usage information, associated with the decision gate control configuration, indicative of the content item, the first reputation decision, and/or the second reputation decision, (ii) evaluating the usage information to determine one or more performance indicators associated with the decision gate control configuration, and (iii) generating, based upon the one or more performance indicators, an updated decision gate control configuration.

In some examples, the method includes (i) executing one or more decision gates of the updated decision gate control configuration to determine a third reputation decision associated with a second content item, and (ii) applying the third reputation decision associated with the second content item.

In some examples, the method includes selecting, based upon speed indicators associated with the one or more first decision gates and the one or more second decision gates (i) the one or more first decision gates for execution in the first reputation decision stage, and (ii) the one or more second decision gates for execution in the second reputation decision stage.

In some examples, the method includes selecting, based upon cost indicators associated with the one or more first decision gates and the one or more second decision gates (i) the one or more first decision gates for execution in the first reputation decision stage, and (ii) the one or more second decision gates for execution in the second reputation decision stage.

In some examples, the method includes selecting, based upon value indicators associated with the one or more first decision gates and the one or more second decision gates (i) the one or more first decision gates for execution in the first reputation decision stage, and (ii) the one or more second decision gates for execution in the second reputation decision stage.

In some examples, a method is provided. The method includes (i) generating a decision gate control configuration including an arrangement of decision gates based upon decision gate profiles associated with the decision gates, wherein a decision gate profile of the decision gate profiles is indicative of a speed indicator associated with a decision gate, a value indicator associated with the decision gate, a cost indicator associated with the decision gate, and/or an output type associated with the decision gate, (ii) determining a first reputation decision associated with a content item using the decision gate control configuration, and (iii) applying the first reputation decision associated with the content item.

In some examples, applying the first reputation decision includes (i) transmitting an indication of the first reputation decision to a device associated with a service to control access to the content item and/or a resource associated with the content item, and/or (ii) controlling access to the content item and/or the resource associated with the content item based upon the first reputation decision.

In some examples, the method includes (i) logging usage information, associated with the decision gate control configuration, indicative of the content item and/or the first reputation decision associated with the content item, (ii) evaluating the usage information to determine one or more performance indicators associated with the decision gate control configuration, and (iii) generating, based upon the one or more performance indicators, an updated decision gate control configuration.

In some examples, the method includes (i) executing one or more decision gates of the updated decision gate control configuration to determine a second reputation decision associated with a second content item, and (ii) applying the second reputation decision associated with the second content item.

In some examples, a method is provided. The method includes (i) grouping decision gates into a plurality of groups based upon speed indicators and/or output types associated with the decision gates, wherein the plurality of groups includes a first group of decision gates associated with a first set of output types and/or a first speed indicator range, and a second group of decision gates associated with a second set of output types and/or a second speed indicator range, (ii) generating a decision gate control configuration based upon the plurality of groups, and (iii) using the decision gate control configuration to perform a reputation decision process associated with a content item to determine a first reputation decision associated with the content item.

In some examples, the reputation decision process includes (i) at least one of determining a first group reputation decision associated with the content item using the first group of decision gates or determining a second group reputation decision associated with the content item using the second group of decision gates, and (ii) determining the first reputation decision associated with the content item based upon the first group reputation decision and/or the second group reputation decision.

In some examples, determining the first group reputation decision using the first group of decision gates includes (i) executing a first decision gate of the first group of decision gates to determine a first gate reputation decision, (ii) executing a second decision gate of the first group of decision gates to determine a second gate reputation decision, and (iii) determining the first group reputation decision based upon the first gate reputation decision and the second gate reputation decision.

In some examples, generating the decision gate control configuration includes arranging the decision gates in a directed acyclic graph (DAG).

In some examples, generating the decision gate control configuration includes (i) arranging decision gates of the first group of decision gates in parallel with each other in the DAG, and (ii) arranging decision gates of the second group of decision gates in parallel with each other in the DAG.

In some examples, the method includes transmitting an indication of the first reputation decision associated with the content item to a device associated with a service to control access to the content item and/or a resource associated with the content item.

In some examples, the method includes controlling access to the content item and/or a resource associated with the content item based upon the first reputation decision.

The following provides a discussion of some types of computing scenarios in which the disclosed subject matter may be utilized and/or implemented.

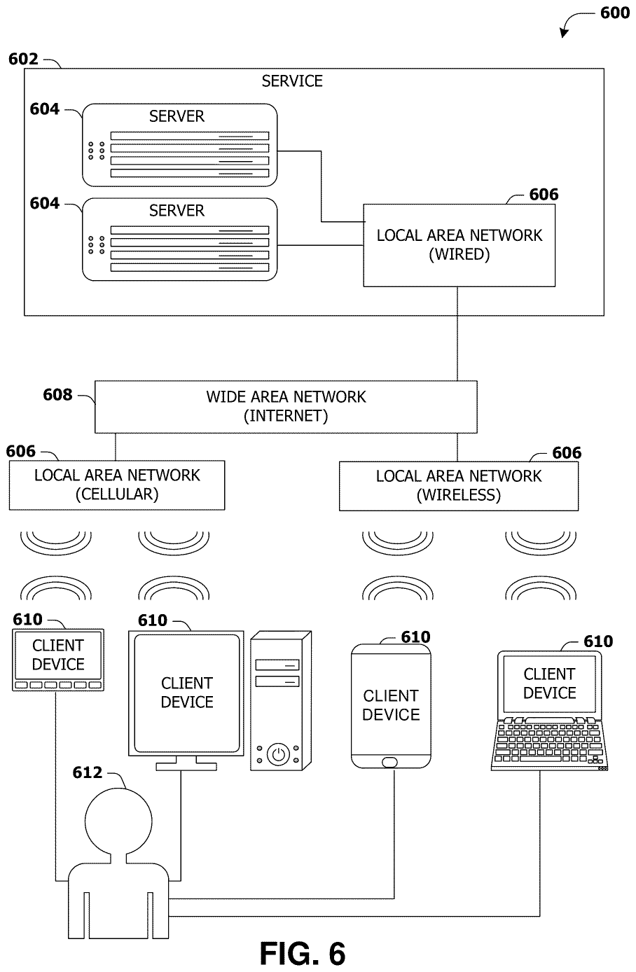

FIG. 6 is an interaction diagram of a scenario 600 in which a service 602 is provided by a set of servers 604 to a set of client devices 610 via various types of networks. The servers 604 and/or client devices 610 may be capable of transmitting, receiving, processing, and/or storing various types of signals, such as in memory as physical memory states. The servers 604 of the service 602 may be internally connected via a local area network 606 (LAN), such as a wired network where network adapters on the respective servers 604 are interconnected via cables (e.g., coaxial and/or fiber optic cabling), and may be connected in various topologies (e.g., buses, token rings, meshes, and/or trees). The servers 604 may be interconnected directly, or through one or more other networking devices, such as routers, switches, and/or repeaters. The servers 604 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 606 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 602.

The local area network 606 may include, for example, analog telephone lines, such as a twisted wire pair, a coaxial cable, Integrated Services Digital Networks (ISDNs), full or fractional digital lines including T1, T2, T3, or T4 type lines, Digital Subscriber Lines (DSLs), wireless links including satellite links, or other communication links or channels, such as may be known to those skilled in the art. Likewise, the local area network 606 may comprise one or more sub-networks, such as may employ differing architectures, may be compliant and/or compatible with differing protocols and/or may interoperate within the local area network 606. Additionally, a variety of local area networks 606 may be interconnected. For example, a router may provide a link between otherwise separate and independent local area networks 606.

In the scenario 600 of FIG. 6, the local area network 606 of the service 602 may be connected to a wide area network 608 (WAN) that allows the service 602 to exchange data with other services 602 and/or client devices 610. The wide area network 608 may encompass various combinations of devices with varying levels of distribution and exposure, such as a public wide-area network (e.g., the Internet) and/or a private network (e.g., a virtual private network (VPN) of a distributed enterprise).

In the scenario 600 of FIG. 6, the service 602 may be accessed via the wide area network 608 by a user 612 of one or more client devices 610, such as a portable media player (e.g., an audio device, an electronic text reader, or a portable gaming, exercise, or navigation device); a portable communication device (e.g., a phone such as a smartphone, a camera, a wearable or a text chatting device); a workstation; and/or a laptop form factor computer. The respective client devices 610 may communicate with the service 602 via various connections to the wide area network 608. As a first such example, one or more client devices 610 may comprise a cellular communicator and may communicate with the service 602 by connecting to the wide area network 608 via a wireless local area network 606 which may be provided by a cellular provider. As a second such example, one or more client devices 610 may communicate with the service 602 by connecting to the wide area network 608 via a wireless local area network 606 (and/or via a wired network) provided by a location such as the user's home or workplace (e.g., a WiFi (Institute of Electrical and Electronics Engineers (IEEE) Standard 802.11) network or a Bluetooth (IEEE Standard 802.15.1) personal area network). In this way, the servers 604 and the client devices 610 may communicate over various types of networks. Other types of networks that may be accessed by the servers 604 and/or client devices 610 include mass storage, such as network attached storage (NAS), a storage area network (SAN), and/or other forms of computer or machine readable media.

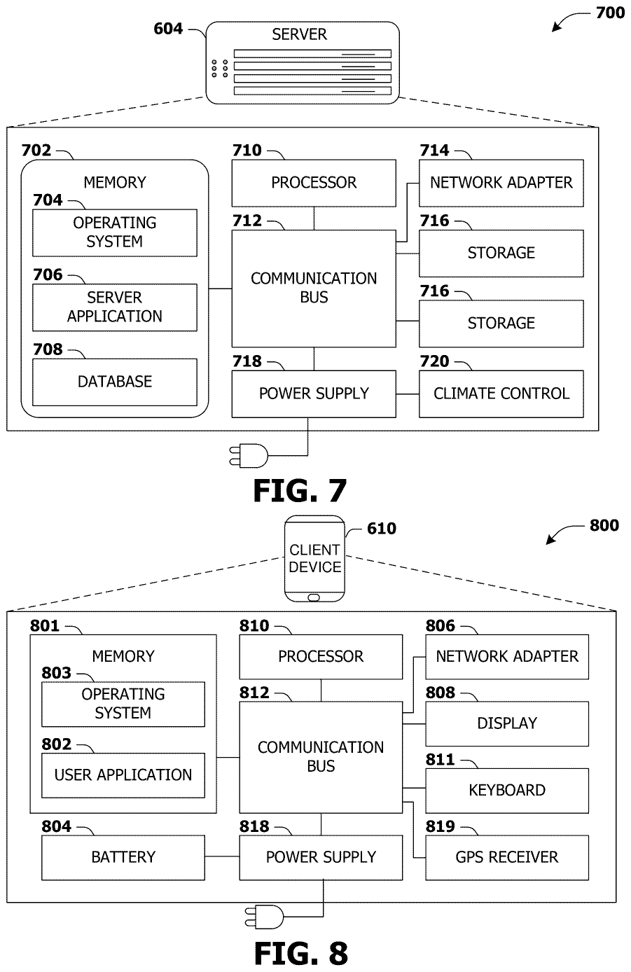

FIG. 7 presents a schematic architecture diagram 700 of a server 604 that may utilize one or more of the techniques provided herein. Such a server 604 may vary widely in configuration or capabilities, alone or in conjunction with other servers, in order to provide a service such as the service 602.

The server 604 may comprise one or more processors 710 that may process instructions. The one or more processors 710 may include a plurality of cores; one or more coprocessors, such as a mathematics coprocessor or an integrated graphical processing unit (GPU); and/or one or more layers of local cache memory. The server 604 may comprise memory 702 storing various forms of applications, such as an operating system 704; one or more server applications 706, such as a hypertext transport protocol (HTTP) server, a file transfer protocol (FTP) server, or a simple mail transport protocol (SMTP) server; and/or various forms of data, such as a database 708 or a file system. The server 604 may comprise peripheral components, such as a wired and/or wireless network adapter 714 connectible to a local area network and/or wide area network; one or more storage components 716, such as a hard disk drive, a solid-state storage device (SSD), a flash memory device, and/or a magnetic and/or optical disk reader.

The server 604 may comprise a mainboard featuring one or more communication buses 712 that interconnect the processor 710, the memory 702, and various peripherals, using a variety of bus technologies, such as a variant of a serial or parallel AT Attachment (ATA) bus protocol; Small Computer System Interface (SCI) bus protocol; and/or a Uniform Serial Bus (USB) protocol. In a multibus scenario, a communication bus 712 may interconnect the server 604 with one or more other servers. Other components that may be included with the server 604 (though not shown in the schematic diagram 700 of FIG. 7) include a display; input peripherals, such as a keyboard and/or mouse; a display adapter, such as a GPU; and a flash memory device that may store a basic input/output system (BIOS) routine that facilitates booting the server 604 to a state of readiness.

The server 604 may operate in various physical enclosures, such as a desktop or tower. The server 604 may be integrated with a display as an “all-in-one” device. The server 604 may be mounted horizontally and/or in a cabinet or rack, and/or may comprise an interconnected set of components. The server 604 may comprise a dedicated and/or shared power supply 718 that may supply and/or regulate power for the other components. The server 604 may provide power to and/or receive power from another server and/or other devices. The server 604 may comprise a shared and/or dedicated climate control unit 720 that may regulate one or more climate properties, such as temperature, humidity, and/or airflow. Many such servers 604 may be configured and/or adapted to utilize at least a portion of the techniques presented herein.

FIG. 8 presents a schematic architecture diagram 800 of a client device 610 whereupon at least a portion of the techniques presented herein may be implemented. Such a client device 610 may vary widely in configuration or capabilities, in order to provide a variety of functionality to a user (e.g., the user 612). The client device 610 may be provided in a variety of form factors, such as a desktop or tower workstation; a laptop, tablet, convertible tablet, or palmtop device; an “all-in-one” device integrated with a display 808; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 610 may serve the user in a variety of roles, such as a workstation, kiosk, gaming device, media player, and/or appliance.

The client device 610 may comprise one or more processors 810 that may process instructions. The one or more processors 810 may include a plurality of cores; one or more coprocessors, such as a mathematics coprocessor or an integrated GPU; and/or one or more layers of local cache memory. The client device 610 may comprise memory 801 storing various forms of applications, such as an operating system 803; drivers for various peripherals; and/or one or more user applications 802, such as document applications, media applications, file and/or data access applications, communication applications such as web browsers and/or email clients, utilities, and/or games. The client device 610 may comprise peripheral components, such as a wired and/or wireless network adapter 806 connectible to a local area network and/or wide area network; one or more output components, such as a display 808 coupled with a display adapter (including a GPU, for example), a sound adapter coupled with a speaker, and/or a printer; input devices for receiving input from the user, such as a keyboard 811, a microphone, a mouse, a camera, and/or a touch-sensitive component of the display 808; and/or environmental sensors, such as a global positioning system (GPS) receiver 819 that detects the location, acceleration, and/or velocity of the client device 610, a compass, accelerometer, and/or gyroscope that detects a physical orientation of the client device 610. Other components that may be included with the client device 610 (though not shown in the schematic architecture diagram 800 of FIG. 8) include one or more storage components, such as a solid-state storage device (SSD), a hard disk drive, a flash memory device, and/or a magnetic and/or optical disk reader; and/or a flash memory device that may store a basic input/output system (BIOS) routine that facilitates booting the client device 610 to a state of readiness; and a climate control unit that regulates one or more climate properties, such as temperature, humidity, and airflow.

The client device 610 may comprise a mainboard featuring one or more communication buses 812 that interconnect the processor 810, the memory 801, and/or one or more peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 610 may comprise a dedicated and/or shared power supply 818 that may supply and/or regulate power for other components, and/or a battery 804 that stores power for use while the client device 610 is not connected to a power source via the power supply 818. The client device 610 may provide power to and/or receive power from other client devices.

In some scenarios, as a user 612 interacts with a software application on a client device 610 (e.g., an instant messenger and/or electronic mail application), descriptive content in the form of signals or stored physical states within memory (e.g., an email address, instant messenger identifier, postal address, phone number, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify one or more circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 610 may include one or more servers that locally serve the client device 610 and/or other client devices of the user 612 and/or other individuals. For example, a locally installed webserver may provide web content in response to locally submitted web requests. Many such client devices 610 may be configured and/or adapted to utilize at least a portion of the techniques presented herein.

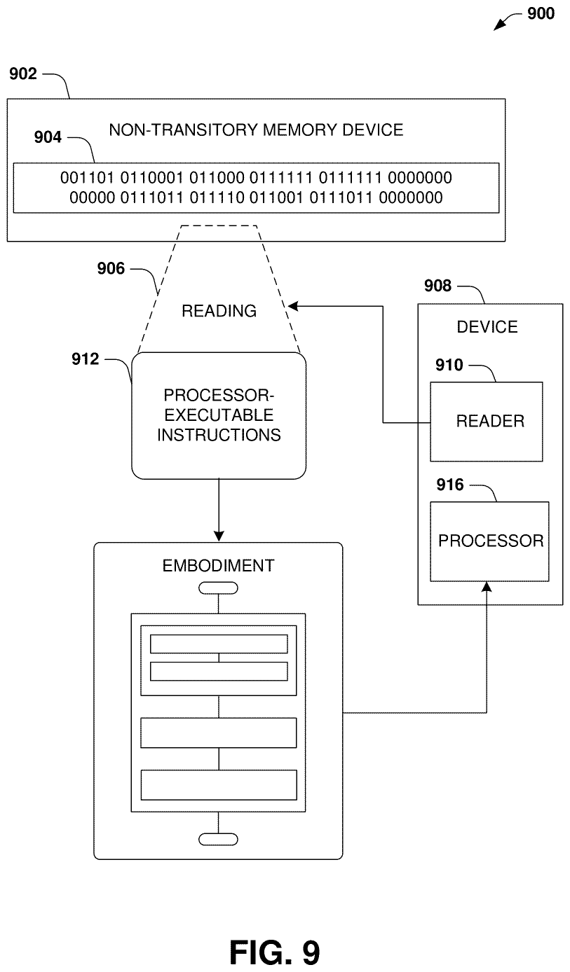

FIG. 9 is an illustration of a scenario 900 involving an example non-transitory machine readable medium 902. The non-transitory machine readable medium 902 may comprise processor-executable instructions 912 that when executed by a processor 916 cause performance (e.g., by the processor 916) of at least some of the provisions herein. The non-transitory machine readable medium 902 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 902 stores computer-readable data 904 that, when subjected to reading 906 by a reader 910 of a device 908 (e.g., a read head of a hard disk drive, or a read operation invoked on a solid-state storage device), express the processor-executable instructions 912. In some embodiments, the processor-executable instructions 912, when executed cause performance of operations, such as at least some of the example method 300 of FIG. 3, at least some of the example method 400 of FIG. 4, and/or at least some of the example method 500 of FIG. 5, for example. In some embodiments, the processor-executable instructions 912 are configured to cause implementation of a system, such as at least some of the example system 101 of FIGS. 1A-1G and/or at least some of the example system 201 of FIGS. 2A-2C, for example.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some and/or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

1. A method of a threat protection system, comprising:
determining a multi-stage decision gate control configuration comprising (i) one or more first decision gates of a first reputation decision stage associated with a real-time reputation decision and (ii) one or more second decision gates of a second reputation decision stage associated with a deeper evaluation reputation decision and different than the one or more first decision gates;
performing a first reputation decision stage, associated with the real-time reputation decision, comprising selectively executing, from the multi-stage decision gate control configuration, the one or more first decision gates of the multi-stage decision gate control configuration to determine a first reputation decision associated with whether a content item is a potential threat corresponding to at least one of maliciousness, phishing or malware;
applying the first reputation decision during a first time period;
performing a second reputation decision stage, associated with the deeper evaluation reputation decision, comprising selectively executing, from the multi-stage decision gate control configuration, the one or more second decision gates of the multi-stage decision gate control configuration to determine a second reputation decision, different than the first reputation decision, associated with whether the content item is a potential threat corresponding to at least one of maliciousness, phishing or malware; and
applying the second reputation decision during a second time period after the first time period.

2. The method of claim 1, wherein:
the second reputation decision stage is performed in response to triggering a deeper evaluation for the content item; and
the deeper evaluation is triggered based upon at least one of:
a confidence score associated with the first reputation decision not meeting a confidence score threshold; or
an activity indicator associated with the content item meeting an activity indicator threshold.

3. The method of claim 1, wherein:
the multi-stage decision gate control configuration further comprises one or more third decision gates of a third reputation decision stage and one or more fourth decision gates;
an arrangement of decision gates in the multi-stage decision gate control configuration, including the one or more first decision gates, the one or more second decision gates, the one or more third decision gates and the one or more fourth decision gates, is used to determine a flow with which the decision gates in the multi-stage decision gate control configuration are executed; and
based upon the arrangement of the decision gates in the multi-stage decision gate control configuration, the flow is determined to comprise (i) a first direction of flow from the one or more first decision gates to the one or more second decision gates, (ii) a second direction of flow from the one or more second decision gates to the one or more third decision gates, and (iii) a third direction of flow from the one or more first decision gates to at least one of the one or more third decision gates or the one or more fourth decision gates.

4. The method of claim 3, wherein:
execution in the first direction of flow, from the one or more first decision gates to the one or more second decision gates, is conditional on one or more first conditions, indicated by the multi-stage decision gate control configuration, being met;
execution in the second direction of flow, from the one or more second decision gates to the one or more third decision gates, is conditional on one or more second conditions, indicated by the multi-stage decision gate control configuration, being met; and
execution in the third direction of flow, from the one or more first decision gates to at least one of the one or more third decision gates or the one or more fourth decision gates, is conditional on one or more third conditions, indicated by the multi-stage decision gate control configuration, being met.

5. The method of claim 1, comprising:
logging usage information, associated with the decision gate control configuration, indicative of at least one of the content item, the first reputation decision, or the second reputation decision;
evaluating the usage information to determine one or more performance indicators associated with the decision gate control configuration; and
generating, based upon the one or more performance indicators, an updated decision gate control configuration, wherein generating the updated multi-stage decision gate control configuration comprises at least one of (i) rearranging one or more decision gates of the multi-stage decision gate control configuration, (ii) modifying one or more conditions associated with a direction of flow between decision gates of the multi-stage decision gate control configuration, (iii) removing a decision gate from the multi-stage decision gate control configuration such that the updated multi-stage decision gate control configuration does not comprise the removed decision gate, (iv) adding a supplemental decision gate that was not included in the multi-stage decision gate control configuration, or (v) modifying one or more decision weights associated with one or more decision gates of the multi-stage decision gate control configuration.

6. The method of claim 5, comprising:
executing one or more decision gates of the updated decision gate control configuration to determine a third reputation decision associated with a second content item; and
applying the third reputation decision associated with the second content item.

7. The method of claim 1, comprising:
prior to performing the first reputation decision stage, selecting:
the one or more first decision gates for execution in the first reputation decision stage based upon a comparison of a speed indicator threshold to one or more first speed indicators indicative of a speed with which the one or more first decision gates are executed determining that the one or more first speed indicators meet the speed indicator threshold; and
the one or more second decision gates for execution in the second reputation decision stage based upon a comparison of the speed indicator threshold to one or more second speed indicators indicative of a speed with which the one or more second decision gates are executed determining that the one or more second speed indicators meet the speed indicator threshold.

8. The method of claim 1, comprising:
prior to performing the first reputation decision stage, selecting:
the one or more first decision gates for execution in the first reputation decision stage based upon a comparison of a cost indicator threshold to one or more first cost indicators indicative of a cost of executing the one or more first decision gates determining that the one or more first cost indicators do not meet the cost indicator threshold; and
the one or more second decision gates for execution in the second reputation decision stage based upon a comparison of the cost indicator threshold to one or more second cost indicators indicative of a cost of executing the one or more second decision gates determining that the one or more second cost indicators meet the cost indicator threshold.

9. The method of claim 1, comprising:
prior to performing the first reputation decision stage, selecting:
the one or more first decision gates for execution in the first reputation decision stage based upon a comparison of a value indicator threshold to one or more first value indicators associated with the one or more first decision gates determining that the one or more first value indicators meet the value indicator threshold; and
the one or more second decision gates for execution in the second reputation decision stage based upon a comparison of the value indicator threshold to one or more second value indicators associated with the one or more first decision gates determining that the one or more second value indicators meet the value indicator threshold.

10. A method comprising:
generating a decision gate control configuration comprising an arrangement of decision gates based upon decision gate profiles associated with the decision gates, wherein a decision gate profile of the decision gate profiles is indicative of at least one of a speed indicator associated with a decision gate, a value indicator associated with the decision gate, a cost indicator associated with the decision gate, or an output type associated with the decision gate;
determining a first reputation decision associated with a content item using the decision gate control configuration; and
applying the first reputation decision associated with the content item.

11. The method of claim 10, wherein applying the first reputation decision comprises at least one of:
transmitting an indication of the first reputation decision to a device associated with a service to control access to at least one of the content item or a resource associated with the content item; or
controlling access to at least one of the content item or the resource associated with the content item based upon the first reputation decision.

12. The method of claim 10, comprising:
logging usage information, associated with the decision gate control configuration, indicative of at least one of the content item or the first reputation decision associated with the content item;
evaluating the usage information to determine one or more performance indicators associated with the decision gate control configuration; and
generating, based upon the one or more performance indicators, an updated decision gate control configuration.

13. The method of claim 12, comprising:
executing one or more decision gates of the updated decision gate control configuration to determine a second reputation decision associated with a second content item; and
applying the second reputation decision associated with the second content item.

14. A method comprising:
grouping decision gates into a plurality of groups based upon at least one of speed indicators or output types associated with the decision gates, wherein the plurality of groups comprises:
a first group of decision gates associated with at least one of a first set of output types or a first speed indicator range; and
a second group of decision gates associated with at least one of a second set of output types or a second speed indicator range;
generating a decision gate control configuration based upon the plurality of groups; and
using the decision gate control configuration to perform a reputation decision process associated with a content item to determine a first reputation decision associated with the content item.

15. The method of claim 14, wherein the reputation decision process comprises:
at least one of:
determining a first group reputation decision associated with the content item using the first group of decision gates; or
determining a second group reputation decision associated with the content item using the second group of decision gates; and
determining the first reputation decision associated with the content item based upon at least one of the first group reputation decision or the second group reputation decision.

16. The method of claim 15, wherein:
determining the first group reputation decision using the first group of decision gates comprises:
executing a first decision gate of the first group of decision gates to determine a first gate reputation decision;
executing a second decision gate of the first group of decision gates to determine a second gate reputation decision; and
determining the first group reputation decision based upon the first gate reputation decision and the second gate reputation decision.

17. The method of claim 14, wherein:
generating the decision gate control configuration comprises arranging the decision gates in a directed acyclic graph (DAG).

18. The method of claim 17, wherein:
generating the decision gate control configuration comprises:
arranging decision gates of the first group of decision gates in parallel with each other in the DAG; and
arranging decision gates of the second group of decision gates in parallel with each other in the DAG.

19. The method of claim 14, comprising:
transmitting an indication of the first reputation decision associated with the content item to a device associated with a service to control access to at least one of the content item or a resource associated with the content item.

20. The method of claim 14, comprising:
controlling access to at least one of the content item or a resource associated with the content item based upon the first reputation decision.
